(19) United States
(12) Patent Application Publication
(10) Pub. No.: US 2023/0054868 A1
(43) Pub. Date: Feb. 23, 2023

(54) METHOD AND SYSTEM FOR ESTIMATING GROUND STATE ENERGY OF QUANTUM SYSTEM

(71) Applicant: TENCENT TECHNOLOGY (SHENZHEN) COMPANY LIMITED, Shenzhen (CN)

(72) Inventors: Shixin ZHANG, Shenzhen (CN); Zhouquan WAN, Shenzhen (CN); Shengyu ZHANG, Hongkong (CN)

(21) Appl. No.: 17/977,344

(22) Filed: Oct. 31, 2022

Related U.S. Application Data
(63) Continuation of application No. PCT/CN2021/124392, filed on Oct. 18, 2021.

(30) Foreign Application Priority Data
Jun. 7, 2021 (CN) 202110634389.5

(51) Int. Cl. G06N 10/60

(52) U.S. Cl. CPC G06N 10/60

(57) ABSTRACT

A method includes: performing transformation processing on input quantum states of n qubits through a parameterized quantum circuit, to output quantum states of the n qubits, an expected energy value of Hamiltonian of a target quantum system in the output quantum states of the n qubits being a summation result of expected energy values of k Pauli strings obtained by decomposing the Hamiltonian, n and k being positive integers; performing post-processing on the output quantum states of the n qubits by using a neural network, and obtaining the expected energy value of the Hamiltonian by calculating a post-processing result of the neural network; adjusting parameters of the parameterized quantum circuit and parameters of the neural network while aiming to converge the expected energy value of the Hamiltonian; and determining the expected energy value of the Hamiltonian satisfying the convergence condition as ground state energy of the target quantum system.

### CROSS-REFERENCES TO RELATED APPLICATIONS

This application is a continuation application of PCT Pat. Application No. PCT/CN2021/124392, entitled “METHOD AND SYSTEM FOR ESTIMATING GROUND STATE ENERGY OF QUANTUM SYSTEM” and filed on Oct. 18, 2021, which claims priority to Chinese Pat. Application No. 202110634389.5, entitled “METHOD AND SYSTEM FOR ESTIMATING GROUND STATE ENERGY OF QUANTUM SYSTEM” and filed with the China National Intellectual Property Administration on Jun. 7, 2021, the entire contents of both of which are incorporated herein by reference.

### FIELD OF THE TECHNOLOGY

Embodiments of the present disclosure relate to the field of quantum technology, and in particular, to a method and system for estimating ground state energy of a quantum system.

### BACKGROUND OF THE DISCLOSURE

Currently, a variational quantum eigensolver (VQE) solution is proposed to estimate ground state energy of a quantum system. The VQE estimates the ground state energy of the quantum system through a variational quantum circuit, which is a typical quantum-classical hybrid computing paradigm.

To further enhance the output performance of the VQE and improve the accuracy of estimating the ground state energy, in the related art a solution of using the Jastrow factor as the post-processing enhancement of the VQE is proposed. The Jastrow factor is used to perform post-processing on a wave function outputted by the variational quantum circuit in the VQE, to describe more quantum entanglement and correlation relationships, so that the final estimated ground state energy is as close as possible to a real value.

However, although the Jastrow factor is more suitable for describing many-body correlation, the Jastrow factor is still not the most common form that classical post-processing may have. Therefore, the expression capability of the Jastrow factor is relatively weak, which affects the accuracy of estimating the ground state energy.

### SUMMARY

Embodiments of the present disclosure provide a method and system for estimating ground state energy of a quantum system. The technical solutions are as follows:

According to an aspect of this embodiment of the present disclosure, a method for estimating ground state energy of a quantum system is provided, performed by a computer device, and the method including: performing transformation processing on input quantum states of n qubits through a parameterized quantum circuit, to output quantum states of the n qubits, an expected energy value of Hamiltonian of a target quantum system in the output quantum states of the n qubits being a summation result of expected energy values of k Pauli strings obtained by decomposing the Hamiltonian, n and k being positive integers; performing post-processing on the output quantum states of the n qubits by using a neural network, and obtaining the expected energy value of the Hamiltonian by calculating a post-processing result of the neural network; adjusting parameters of the parameterized quantum circuit and parameters of the neural network by using a convergence condition of the expected energy value of the Hamiltonian as an objective; and when the expected energy value of the Hamiltonian satisfies the convergence condition, determining the expected energy value of the Hamiltonian satisfying the convergence condition as ground state energy of the target quantum system.

According to an aspect of this embodiment of the present disclosure, an apparatus for estimating ground state energy of a quantum system is provided, including: a state obtaining module, configured to perform transformation processing on input quantum states of the n qubits through a parameterized quantum circuit to obtain output quantum states of the n qubits, an expected energy value of Hamiltonian of a target quantum system in the output quantum states of the n qubits being a summation result of expected energy values of k Pauli strings obtained by decomposing the Hamiltonian, n being a positive integer, and k being a positive integer; a post-processing module, configured to perform post-processing on the output quantum states of the n qubits by using a neural network, and obtain the expected energy value of the Hamiltonian by calculating a post-processing result of the neural network; and an optimizer module, configured to adjust parameters of the parameterized quantum circuit and parameters of the neural network by using a convergence condition of the expected energy value of the Hamiltonian as an objective; and when the expected energy value of the Hamiltonian satisfies the convergence condition, determine the expected energy value of the Hamiltonian satisfying the convergence condition as ground state energy of the target quantum system.

According to an aspect of this embodiment of the present disclosure, a computer device is provided, including a processor and a memory, the memory storing a computer program, the computer program being loaded and executed by the processor to implement the foregoing method.

According to an aspect of this embodiment of the present disclosure, a non-transitory computer-readable storage medium is provided, storing a computer program, the computer program being loaded and executed by a processor to implement the foregoing method.

According to an aspect of this embodiment of the present disclosure, a system for estimating ground state energy of a quantum system is provided, including: a parameterized quantum circuit and a computer device, the computer device including a post-processor and an optimizer. The parameterized quantum circuit is used for performing transformation processing on input quantum states of n qubits to obtain output quantum states of the n qubits, an expected energy value of Hamiltonian of a target quantum system in the output quantum states of the n qubits being a summation result of expected energy values of k Pauli strings obtained by decomposing the Hamiltonian, n being a positive integer, and k being a positive integer; the post-processor being configured to perform post-processing on the output quantum states of the n qubits by using a neural network, and obtain the expected energy value of the Hamiltonian by calculating a post-processing result of the neural network; and the optimizer being configured to adjust parameters of the parameterized quantum circuit and parameters of the neural network with convergence of the expected energy value of the Hamiltonian as an objective; and when the expected energy value of the Hamiltonian satisfies a convergence condition, determine the expected energy value of the Hamiltonian satisfying the convergence condition as ground state energy of the target quantum system.

The technical solutions provided in the embodiments of the present disclosure may include the following beneficial effects:

A neural network is used for performing post-processing on a wave function outputted through the parameterized quantum circuit. The neural network may play the role of a general function approximator, which has stronger expression capability and ground state energy approximation capability than the Jastrow factor, thereby helping to improve the accuracy of estimating the ground state energy.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other accompanying drawings from the accompanying drawings without creative efforts.

FIG. 1(b) is a schematic diagram of a VQNHE framework according to an embodiment of the present disclosure.

FIG. 2 is a flowchart of a method for estimating ground state energy of a quantum system according to an embodiment of the present disclosure.

FIG. 3 is a schematic diagram of a VQNHE framework according to another embodiment of the present disclosure.

FIG. 4 is a flowchart of a method for estimating ground state energy of a quantum system according to another embodiment of the present disclosure.

FIG. 5 is a schematic diagram of a measurement circuit according to an embodiment of the present disclosure.

FIG. 6 is a schematic diagram of a measurement circuit according to another embodiment of the present disclosure.

FIG. 7 is a schematic diagram of a comparison of various solutions in molecular energy computing exemplarily shown in the present disclosure.

FIG. 8 is a schematic diagram of a quantum circuit structure in molecular energy computing exemplarily shown in the present disclosure.

FIG. 9 is a diagram of a comparison of performance of a VQE and a VQNHE on real hardware and a noisy simulator exemplarily shown in the present disclosure.

FIG. 10 is a schematic diagram of a PQC circuit structure exemplarily shown in the present disclosure.

FIG. 11 is a block diagram of an apparatus for estimating ground state energy of a quantum system according to an embodiment of the present disclosure.

FIG. 12 is a schematic structural diagram of a computer device according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

Before technical solutions of the present disclosure are described, some key terms involved in the present disclosure are explained first.

1. Quantum computing: Quantum computing is a computing manner based on quantum logic, and a basic unit for storing data is a qubit.

2. Quantum bit (Qubit): A qubit is a basic unit of quantum computing. A traditional computer uses 0 and 1 as basic units of binary. A difference is that the quantum computing may simultaneously process 0 and 1, and the system may be in a circuitar superposition state of 0 and 1: |Ψ〉 = α|0〉 + β|1〉, where α, β represents a complex probability amplitude of the system on 0 and 1. Their modulo squares |α|²,| | β|² respectively represent probability of being at 0 and 1.

3. Quantum circuit: A quantum circuit is a representation of a quantum universal computer, and represents a hardware implementation of the corresponding quantum algorithm/program under a quantum gate model. If the quantum circuit includes adjustable parameters that control a quantum gate, the quantum circuit is referred to as a parameterized quantum circuit (PQC) or a variational quantum circuit (VQC), both of which are the same concept. In some embodiments, a quantum circuit is a computational routine consisting of coherent quantum operations on quantum data, such as qubits, and concurrent real-time classical computation. It is an ordered sequence of quantum gates, measurements, and resets, which may be conditioned on and use data from the real-time classical computation.

4. Hamiltonian: Hamiltonian is a Hermitian conjugate matrix describing total energy of a quantum system. The Hamiltonian is a physical word and an operator that describes total energy of a system, which is usually denoted by H.

5. Eigenstate: For a Hamiltonian matrix H, a solution that satisfies an equation H|Ψ〉 = E|Ψ〉 is referred to as eigenstate |Ψ〉 of H, and has eigenenergy E. A ground state corresponds to the eigenstate with the lowest quantum system energy.

6. Quantum architecture search (QAS): Quantum architecture search is a general term for a series of operations and solutions that attempt to perform automatic and programmatic search on a structure, a pattern, and arrangement of the quantum circuit. In some cases, in the operation of the quantum structure search, a greedy algorithm, reinforcement learning, or a genetic algorithm is usually adopted as the core technology of the quantum structure search. The recently developed technology includes differentiable quantum structure search and a predictor-based structure search solution.

7. Quantum-classical hybrid computing: Quantum-classical hybrid computing is an inner layer that calculates the corresponding physical quantity or loss function by using a quantum circuit (such as PQC). A computing paradigm in which variational parameters of the quantum circuit are adjusted by a classical optimizer in an outer layer may maximize advantages of quantum computing, and is believed to be one of the important directions that has the potential to prove quantum advantage.

8. Noisy intermediate-scale quantum (NISQ): Noisy intermediate-scale quantum hardware in the near future is a current stage of quantum computing development and a key direction of research. At this stage, quantum computing cannot be used as an engine for general-purpose computing due to limitations of scale and noise. However, in some problems, results that surpass the most powerful classical computer have been achieved, which is often referred to as quantum supremacy or quantum advantage.

9. Quantum error mitigation: Corresponding to quantum error correction, quantum error mitigation is a series of quantum error mitigation and noise suppression solutions with lower resource cost in hardware of the NISQ era. Compared with full quantum error correction, resources required are significantly reduced, and may only be applicable to a specific task, rather than a general solution.

10. Variational quantum eigensolver (VQE): Estimation of ground state energy of a given quantum system is implemented through a variational circuit (that ism PQC/VQC). A variational quantum eigensolver is a typical quantum-classical hybrid computing paradigm and has a wide range of applications in the field of quantum chemistry.

11. Jastrow factor: The Jastrow factor is a factor commonly used in the simulacrum of a variational Monte Carlo wave function, and is used to strengthen the wave function without interaction in a mean field, to describe more quantum correlation information. A basic form is P(Φ) = exp(Σₖₗ Φₖₗ ZₖZₗ), where Φ is a variation parameter, Z is a quantum operator that gives ±1 eigenvalues on a measurement basis, ^{k} and ^{l} represent different qubit degrees of freedom, ^{k} represents a ^{k}^{th} qubit, and ^{l} represents a ^{l}^{th} qubit.

12. Non-unitary: A so-called unitary matrix is all matrices that satisfy U ^{†}U= I , and all evolution processes directly allowed by quantum mechanics may be described by the unitary matrix. U is a unitary matrix. U ^{†} is a conjugate transpose of ^{U} . In addition, matrices that do not satisfy the condition are non-unitary, which may only be implemented experimentally through auxiliary means or even exponentially more resources, but non-unitary matrices often have stronger expression capability and faster ground-state projection effects. The “exponentially more resources” refers to that a demand for resources increases exponentially with the increase of the quantity of qubits. The exponentially more resources may refer to that the total quantity of to-be-measured quantum circuits is exponentially more, that is, correspondingly, exponentially more computing time is required.

13. Pauli string: An item includes a direct product of a plurality of Pauli operators at different grids. A general Hamiltonian may usually be decomposed into a direct product of a set of Pauli strings. The measurement of VQE is also generally measured item by item according to the decomposition of the Pauli string.

14. Pauli operator: A Pauli operator is also referred to as a Pauli matrix, is a group of three 2×2 unitary Hermitian complex matrices (also referred to as unitary matrices), and is generally represented by the Greek letter σ (Sigma). A Pauli X operator is

$${σ}_{x} = \left[\begin{matrix}0 & 1 \\ 1 & 0\end{matrix}\right]$$

, a Pauli Y operator is

$${σ}_{y} = \left[\begin{matrix}0 & - i \\ i & 0\end{matrix}\right]$$

, and a Pauli Z operator is

$${σ}_{z} = \left[\begin{matrix}1 & 0 \\ 0 & - 1\end{matrix}\right]$$

.

15. Unitary coupled cluster (UCC) ansatz and hardware efficient ansatz: UCC ansatz and hardware efficient ansatz are two different variational circuit structures of the VQE. The former draws on a variational numerical method coupled-cluster of quantum chemistry, and the approximation effect is better, but the former needs Trotter to decompose a corresponding exponential operator, which has a relatively high requirement on quantum resources. The latter adopts a policy of directly packing a native quantum gate group, which requires relatively shallow circuits and relatively less quantum resource requirements, but the corresponding expression and approximation capabilities are also worse than the UCC ansatz.

16. Bit string: A bit string is a string of numbers including 0 and 1. A classical result obtained by each measurement of the quantum circuit may be respectively represented by 0 and 1 according to the upper and lower spin configurations on a measurement basis, so that a total result of one measurement corresponds to a bit string.

The technical solutions provided in the present disclosure help to speed up and strengthen the development and design of a variational quantum algorithm at the current stage. Typical shortcomings of quantum hardware in the NISQ era are short coherence time and large quantum noise. Correspondingly, a depth of the quantum circuit is minimized when specific characteristics of quantum hardware are fully considered. A VQE solution based on the UCC ansatz often has relatively high accuracy but high requirements on the depth of the circuit, and therefore is difficult to be implemented at large scale on quantum hardware of the existing coherence time. In contrast, the hardware-saving hypothesis may be used as a circuit structure through close-packing of native quantum gates. The benefit is that a variational structure is easy to be implemented on the quantum hardware, but the expression capability and approximation capability to the ground state are often unsatisfactory. The technical solution provided in the present disclosure may be referred to as a variational quantum neural network hybrid eigensolver (VQNHE), which precisely resolves the pair of contradicts. With general non-unitary post-processing supported by the neural network, ground state energy approximation may be enhanced beyond physical/chemical precision requirements on a relatively shallow variational quantum circuit. Therefore, the solution is particularly suitable for the application of the quantum hardware at the current stage, thereby accelerating the verification and commercial application of effective quantum advantage.

In addition, the technical solutions provided in the present disclosure may be applicable to quantum hardware evaluation and practical production in the short to medium term. Applications include, but are not limited to, simulating and solving a plurality of ground states of the Hamiltonian from problems in condensed matter physics and quantum chemistry. The technical solutions provided in the present disclosure are also expected to further play a role in a task supported by other variational quantum algorithms, such as excited state search and quantum time-dependent evolution. In addition, in the technical solutions provided in the present disclosure, a neural network model is further optimized, which may achieve a specific effect of quantum error correction based on a model with no prior noise, thereby further releasing the huge potential of the solution in the NISQ era. Because the algorithm may be used as a general solution for VQE enhancement, and quantum resources consumed by the algorithm are the same as quantum resources consumed by a general VQE, any VQE program (used for performing a measurement and estimation process under the entire system architecture) may be seamlessly ported to a VQNHE framework. The framework may be provided and invoked as a quantum cloud service, and may be encapsulated into a very simple VQE-enhanced application programming interface (API). In addition, the solution may be combined with a quantum structure search method to further adaptively construct a quantum circuit structure suitable for the VQNHE.

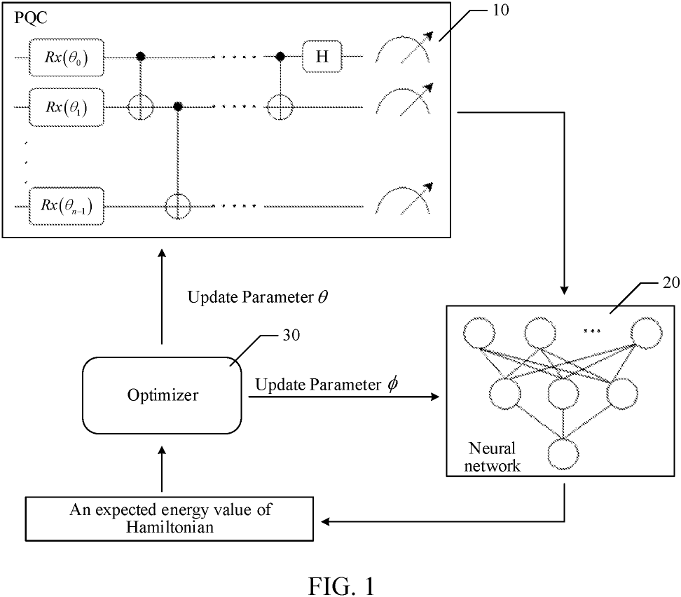

As shown in FIG. 1, the VQNHE framework provided in an exemplary embodiment of the present disclosure includes a parameterized quantum circuit (PQC) 10, a neural network 20, and an optimizer 30. The neural network 20 and the optimizer 30 may be functional modules deployed in a computer device, and the optimizer 30 may also be referred to as an optimizer module. In this embodiment of the present disclosure, the computer device may be a classical computer that executes a computer program by a processor to implement the method, which has storage and computing capabilities. The parameterized quantum circuit 10 is used for performing transformation processing on input quantum states of n qubits to obtain output quantum states of the n qubits, n being a positive integer An expected energy value of Hamiltonian of a target quantum system in the output quantum states of the n qubits is a summation result of expected energy values of k Pauli strings obtained by decomposing the Hamiltonian, k being a positive integer. The neural network 20 is used for performing post-processing on the output quantum states of the n qubits. Based on a post-processing result of the neural network 20, the expected energy values of the k Pauli strings are obtained, and then the expected energy value of the Hamiltonian is calculated. The optimizer 30 is used for adjusting parameters of the parameterized quantum circuit 10 and parameters of the neural network 20 with convergence of the expected energy value of the Hamiltonian as an objective. When the expected energy value of the Hamiltonian satisfies a convergence condition, the expected energy value of the Hamiltonian satisfying the convergence condition is determined as ground state energy of the target quantum system.

The parameterized quantum circuit (PQC) 10 in the upper left corner in FIG. 1 is consistent with a VQE framework. An output wave function |Ψ〉 is subjected to the action of a neural network post-processing operator

$$\hat{f} = \sum {}_{s} {f}_{ϕ} ( s ) \left|s\right〉 \left〈s\right|$$

, to obtain an enhanced quantum-neural network hybrid wave function:

$$\left|{Ψ}_{f}\right〉 = {\hat{f}}_{ϕ} U ( θ ) \left|0\right〉$$

To measure and estimate the expected energy value of the Hamiltonian corresponding to |Ψ_{f〉}, the following manner may be used. For each Pauli string in the k Pauli strings, bit strings of the output quantum states of the n qubits on the measurement basis corresponding to the Pauli string are respectively measured and obtained. The metadata used for calculating the expected energy value of the Pauli string is outputted by the neural network 20 according to the bit strings, and then the expected energy value of the Pauli string is calculated and obtained according to the metadata. Finally, summation processing is performed on the expected energy values of the k Pauli strings to obtain the expected energy value of the Hamiltonian. Once the expected energy value of the Hamiltonian is obtained, parameter translation and backpropagation may be respectively applied to calculate derivatives of the expected energy value relative to a parameter θ of the parameterized quantum circuit 10 and a derivative of a parameter Φ of the neural network 20. Through the derivative information, the gradient-based optimizer 30 (such as Adam) developed by a classical machine learning community may be used for updating the corresponding parameters, thereby completing a round of iteration of a quantum-classical hybrid computing paradigm until the obtained energy expectation value converges, and the value may be used as an approximate estimation of the ground state of the Hamiltonian of a corresponding system.

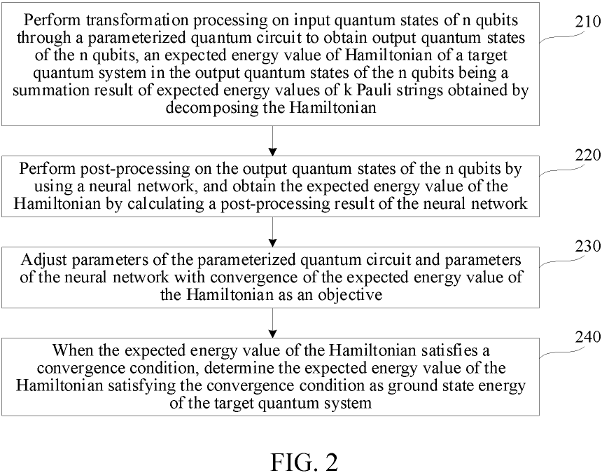

FIG. 2 is a flowchart of a method for estimating ground state energy of a quantum system according to an embodiment of the present disclosure. The method may be applicable to the VQNHE framework shown in FIG. 1, for example, an execution entity of each step of the method may be a computer device. The method may include the following steps (210 to 240):

Step 210. Performing transformation processing on input quantum states of n qubits through a parameterized quantum circuit to obtain output quantum states of the n qubits, an expected energy value of Hamiltonian of a target quantum system in the output quantum states of the n qubits being a summation result of expected energy values of k Pauli strings obtained by decomposing the Hamiltonian, n being a positive integer, and k being a positive integer.

In this embodiment of the present disclosure, the parameterized quantum circuit is used for performing transformation processing on input quantum states of n qubits to obtain output quantum states of the n qubits.

An input quantum state of the parameterized quantum circuit may generally use an all-zero state, a uniform superposition state, or a Hartree-Fock state, and the input quantum state is also referred to as a tentative state. The Hamiltonian of the target quantum system may be decomposed into a direct product of k Pauli strings, where k is usually an integer greater than 1. However, in some special cases, k may also be equal to 1, that is, the Hamiltonian of the target quantum system may be regarded as a Pauli string. Therefore, in the VQE framework, an output quantum state of the target quantum system is approximated by the output of the parameterized quantum circuit. The expected energy value of the Hamiltonian of the target quantum system in the output quantum state of the parameterized quantum circuit is measured and estimated, and the parameters of the parameterized quantum circuit are continuously optimized to adjust the output quantum state by minimizing the expected energy value, so that the expected energy value of the Hamiltonian of the target quantum system in the output quantum state tends to be the minimized, and finally the ground state energy of the target quantum system is obtained.

Step 220. Perform post-processing on the output quantum states of the n qubits by using a neural network, and obtain the expected energy value of the Hamiltonian by calculating a post-processing result of the neural network.

In the VQNHE framework provided in the present disclosure, a neural network is used for performing post-processing on a wave function outputted by the parameterized quantum circuit. The neural network may play the role of a general function approximator, which has stronger expression capability and ground state energy approximation capability than the Jastrow factor, thereby helping to improve the accuracy of estimating the ground state energy.

In some embodiments, the step 220 includes the following substeps:

1. A plurality of Pauli strings corresponding to equivalent Hamiltonian of the target quantum system are generated according to a Pauli string obtained by decomposing the Hamiltonian of the target quantum system and a Pauli string obtained by decomposing a post-processing operator corresponding to the neural network;

in some embodiments, Taylor expansion is performed on the post-processing operator corresponding to the neural network to obtain t Pauli strings, where t is a positive integer; and a direct product operation is performed on the k Pauli strings obtained by decomposing the Hamiltonian of the t Pauli strings and the target quantum system and to generate a plurality of Pauli strings corresponding to the equivalent Hamiltonian of the target quantum system. The equivalent Hamiltonian of the target quantum system is a direct product of a plurality of Pauli strings corresponding to the target quantum system.

In some embodiments, a maximum quantity of the plurality of Pauli strings corresponding to the equivalent Hamiltonian of the target quantum system is ^{t} × ^{t} × ^{k} .

2. For each Pauli string in the plurality of Pauli strings corresponding to the equivalent Hamiltonian, a bit string of the output quantum states of the n qubits on a measurement basis corresponding to the Pauli string is obtained by measurement;

3. an expected energy value corresponding to each of the plurality of Pauli strings respectively is calculated and obtained according to a bit string corresponding to each of the plurality of Pauli strings respectively; and

4. the expected energy value of the Hamiltonian is calculated according to the expected energy value corresponding to each of the plurality of Pauli strings respectively.

Using a measurement basis Z as an example, the Taylor expansion formula of a post-processing operator

$$\hat{f}$$

corresponding to the neural network is as follows:

$$\hat{f} = \sum {}_{{}_{i j k …}} {c}_{i j k …} {Z}_{i} {Z}_{j} {Z}_{k} … ,$$

where

$${c}_{i j k …}$$

represents a coefficient corresponding to

$${Z}_{i} {Z}_{j} {Z}_{k}$$

, c_{ijk...} is determined based on the parameters of the neural network, Zᵢ is a Z Pauli operator on the i^{th} qubit, Zⱼ is the Z Pauli operator on the j^{th} qubit, Zₖ is the Z Pauli operator on the k^{th} qubit, and so on. Through the Taylor expansion, exponentially more Pauli strings may be obtained, that is, t is exponentially related to the quantity n of qubits. The equivalent Hamiltonian of the target quantum system is equal to a direct product of t Pauli strings, the Hamiltonian of the target quantum system, and t the Pauli strings, and the Hamiltonian of the target quantum system may be decomposed into a direct product of the k Pauli strings. Therefore, the expected energy value corresponding to each of the t × t × k Pauli strings needs to be measured at most. For each Pauli string in the t × t × k Pauli strings, a plurality of measurements are respectively performed, to obtain an energy calculation result based on the bit string obtained by each measurement. Then the energy calculation result obtained from the plurality of measurements are averaged to obtain the expected energy value of the Pauli string. The expected energy value of the equivalent Hamiltonian of the target quantum system on the output quantum state of the PQC is equal to the expected energy value of the original Hamiltonian of the target quantum system on a post-processing wave function. Therefore, calculating the expected energy value of the original Hamiltonian of the target quantum system is equivalent to calculating the expected energy value of the equivalent Hamiltonian of the target quantum system. The expected energy value

$$E ∝ \left〈ψ \left|\hat{f} \hat{H} \hat{f}\right| ψ\right〉 = \left〈ψ \left|{\hat{H}}^{′}\right| ψ\right〉$$

of the equivalent Hamiltonian, where

$${\hat{H}}^{′} = \hat{f} \hat{H} \hat{f}$$

corresponds to the summation result of the expected energy values of t × t × k Pauli strings. For example, the expected energy values of the t × t × k Pauli strings are added to obtain the expected energy value of the equivalent Hamiltonian. The addition may be direct addition or weighted summation, which is not limited in the present disclosure.

In this embodiment of the present disclosure, a specific structure of the neural network is not limited, and may be a simple fully connected structure or other relatively complex structures, which are not limited in the present disclosure.

Step 230. Adjust parameters of the parameterized quantum circuit and parameters of the neural network with convergence of the expected energy value of the Hamiltonian as an obj ective.

In some embodiments, derivatives of the expected energy value of the Hamiltonian relative to the parameters of the parameterized quantum circuit and derivatives relative to the parameters of the neural network are respectively calculated. Then, based on the derivative information, the parameters of the parameterized quantum circuit and the parameters of the neural network are respectively adjusted by a gradient descent method, so that the expected energy value of the Hamiltonian tends to be minimized. A parameter optimization process of the parameterized quantum circuit and a parameter optimization process of the neural network may be simultaneously performed or sequentially performed, which is not limited in the present disclosure.

Step 240. When the expected energy value of the Hamiltonian satisfies a convergence condition, determine the expected energy value of the Hamiltonian satisfying the convergence condition as ground state energy of the target quantum system.

Finally, a minimum value of the expected energy value of the Hamiltonian is determined as the ground state energy of the target quantum system.

In this embodiment of the present disclosure, a neural network is used for performing post-processing on a wave function outputted by the parameterized quantum circuit. The neural network may play the role of a general function approximator, which has stronger expression capability and ground state energy approximation capability than the Jastrow factor, thereby helping to improve the accuracy of estimating the ground state energy.

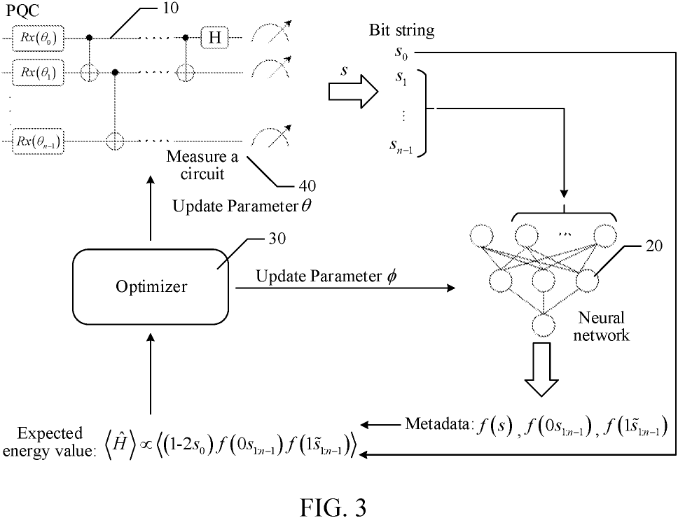

As shown in FIG. 3, the VQNHE framework provided in another exemplary embodiment of the present disclosure includes a parameterized quantum circuit (PQC) 10, a measurement circuit 40, a neural network 20, and an optimizer 30. The neural network 20 and the optimizer 30 may be functional modules deployed in a computer device, and the optimizer 30 may also be referred to as an optimizer module. In this embodiment of the present disclosure, the computer device may be a classical computer that executes a computer program by a processor to implement the method, which has storage and computing capabilities. The measurement circuit 40 includes k groups of measurement circuits, and the k groups of measurement circuits are in one-to-one correspondence with the k Pauli strings obtained by decomposing the Hamiltonian. In some embodiments, the measurement circuit can refer to measurement operations performed on a quibit in accordance with gates, and a configuration of the measurement circuit (e.g., gates in the measurement circuit) can be determined by a computing device for a specific quantum computing task. The parameterized quantum circuit 10 is used for performing transformation processing on input quantum states of n qubits to obtain output quantum states of the n qubits, n being a positive integer An expected energy value of Hamiltonian of a target quantum system in the output quantum states of the n qubits is a summation result of expected energy values of k Pauli strings obtained by decomposing the Hamiltonian, k being a positive integer. For a target Pauli string in the k Pauli strings, a measurement circuit corresponding to the target Pauli string is used for performing transformation processing corresponding to the target Pauli string on the output quantum states of the n qubits to obtain the transformed output quantum state. The neural network 20 is used for performing post-processing on the transformed output quantum state. Based on a post-processing result of the neural network 20, the expected energy value of the target Pauli string is obtained. For the k Pauli strings, the operations are respectively performed to obtain the expected energy value corresponding to each of the k Pauli strings respectively, and then obtain the expected energy value of the Hamiltonian by summation. The optimizer 30 is used for adjusting parameters of the parameterized quantum circuit 10 and parameters of the neural network 20 with convergence of the expected energy value of the Hamiltonian as an objective. When the expected energy value of the Hamiltonian satisfies a convergence condition, the expected energy value of the Hamiltonian satisfying the convergence condition is determined as ground state energy of the target quantum system.

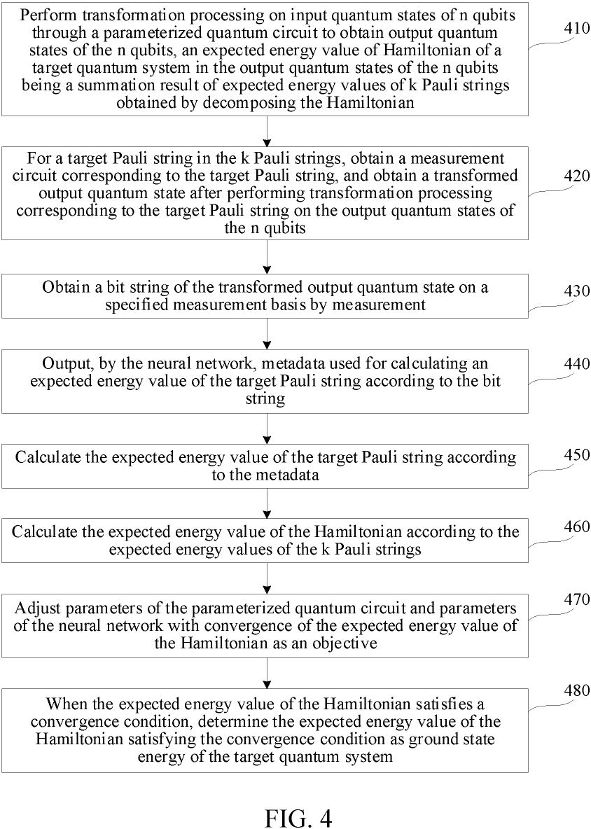

FIG. 4 is a flowchart of a method for estimating ground state energy of a quantum system according to another embodiment of the present disclosure. The method may be applicable to the VQNHE framework shown in FIG. 3. For example, an execution entity of each step of the method may be a computer device. The computer device may be a classical computer that executes a computer program by a processor to implement the method, which has storage and computing capabilities. The method may include the following steps (410 to 480):

Step 410. Performing transformation processing on input quantum states of n qubits through a parameterized quantum circuit to obtain output quantum states of the n qubits, an expected energy value of Hamiltonian of a target quantum system in the output quantum states of the n qubits being a summation result of expected energy values of k Pauli strings obtained by decomposing the Hamiltonian, n being a positive integer, and k being a positive integer.

In this embodiment, the expected energy value respectively corresponding to each of the k Pauli strings obtained by decomposing the Hamiltonian is directly calculated. Then, the expected energy value of the Hamiltonian of the target quantum system is calculated according to the expected energy value corresponding to each of the k Pauli strings respectively. In some embodiments, summation processing is performed on the expected energy value corresponding to each of the k Pauli strings respectively, and an obtained summation result is used as the expected energy value of the Hamiltonian of the target quantum system. The summation processing may be direct addition or weighted summation, which is not limited in the present disclosure.

In the foregoing embodiment, the expected energy value respectively corresponding to each of a plurality of Pauli strings obtained by decomposing equivalent Hamiltonian of the target quantum system is calculated. Summation processing is respectively performed on the expected energy value corresponding to each of the plurality of Pauli strings to obtain the expected energy value of the equivalent Hamiltonian. The expected energy value of the equivalent Hamiltonian is used as the expected energy value of the Hamiltonian of the target quantum system. The manner is relatively complicated and inefficient because in the manner, the expected energy value respectively corresponding to each of the t × t × k Pauli strings may need to be calculated at most. In the manner provided in this embodiment, by introducing a measurement circuit, the expected energy value respectively corresponding to each of the k Pauli strings needs to be calculated, which is simpler and more efficient.

Step 420. For a target Pauli string in the k Pauli strings, obtain or configure a measurement circuit corresponding to the target Pauli string, and obtain a transformed output quantum state after performing transformation processing corresponding to the target Pauli string on the output quantum states of the n qubits.

In some embodiments, for a target Pauli string in the k Pauli strings, a measurement circuit corresponding to the target Pauli string is configured to be used for performing transformation processing corresponding to the target Pauli string on the output quantum states of the n qubits to obtain the transformed output quantum state.

For the k Pauli strings obtained by decomposing the Hamiltonian, the expected energy value is obtained by measuring and estimating one by one. The VQNHE framework shown in FIG. 3 includes k groups of measurement circuits, and the k groups of measurement circuits are in one-to-one correspondence with the k Pauli strings. The target Pauli string may be any one of the k Pauli strings. When measuring and estimating the expected energy value of the target Pauli string, the measurement circuit corresponding to the target Pauli string is used to perform transformation processing on the output quantum state of the parameterized quantum circuit corresponding to the target Pauli string to obtain the transformed output quantum state. The objective of the step of transformation is to reduce the resource consumption in the measurement and estimation process. For the specific principle, reference may be made to the derivation analysis below.

In an exemplary embodiment, the measurement circuit corresponding to the target Pauli string is configured to include a quantum gate corresponding to an unsigned qubit other than signed qubits, so that the unsigned qubit is measured on a same measurement basis, where the signed qubit is a qubit in the n qubits that corresponds to a target Pauli operator in the target Pauli string, and a measurement basis corresponding to the signed qubit is determined according to a Pauli operator corresponding to the signed qubit in the target Pauli string. A quantum gate corresponding to each unsigned qubit is a two-bit quantum gate, which is simultaneously applied on both the signed qubit and the unsigned qubit.

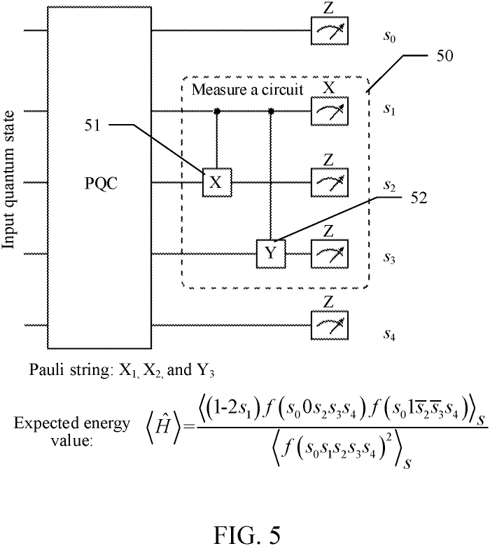

Using the measurement circuit shown in FIG. 5 as an example, the target Pauli string is I₀, X₁, X₂, Y₃, and I₄, where the I operator may be ignored. Therefore, the target Pauli string may be recorded as X₁, X₂, and Y₃. Assuming that the measurement is to be performed on the measurement basis Z, the second qubit (corresponding to the Pauli operator X₁) may be used as a signed qubit, and other qubits are unsigned qubits. In this case, the measurement circuit 50 corresponding to the target Pauli string includes a two-bit controlled X gate 51 applied on the second qubit (that is, the signed qubit), the third qubit (corresponding to the Pauli operator X₂), a two-bit controlled Y gate 52 applied on the second qubit (that is, the signed qubit), and the fourth qubit (corresponding to the Pauli operator Y₃). In addition, the measurement basis corresponding to the signed qubit is determined according to the Pauli operator corresponding to the signed qubit in the target Pauli string. In the example, the second qubit is the signed qubit, which corresponds to the Pauli operator X₁, and therefore corresponds to the measurement basis X.

In some embodiments, the same measurement basis is a measurement basis corresponding to a first Pauli operator, and the target Pauli operator is a second Pauli operator or a third Pauli operator, where the first Pauli operator, the second Pauli operator, and the third Pauli operator are different from each other, and any Pauli operator of the first Pauli operator, the second Pauli operator, and the third Pauli operator is one of a Pauli X operator, a Pauli Y operator, and a Pauli Z operator. That is, when the same measurement basis is a measurement basis X, the signed qubit is a specific qubit corresponding to the Pauli Y or the Z operator; when the same measurement basis is a measurement basis Y, the signed qubit is a specific qubit corresponding to the Pauli X or the Z operator; and when the same measurement basis is a measurement basis Z, the signed qubit is a specific qubit corresponding to the Pauli X or the Y operator.

In some embodiments, for the unsigned qubit, a quantum gate corresponding to the unsigned qubit is a two-bit controlled X gate when the unsigned qubit corresponds to the Pauli X operator in the target Pauli string; the quantum gate corresponding to the unsigned qubit is a two-bit controlled Y gate when the unsigned qubit corresponds to the Pauli Y operator in the target Pauli string; or the quantum gate corresponding to the unsigned qubit is a two-bit controlled Z gate when the unsigned qubit corresponds to the Pauli Z operator in the target Pauli string.

In some embodiments, for a signed qubit, when the signed qubit corresponds to a Pauli X operator in the target Pauli string, the measurement basis corresponding to the signed qubit is the measurement basis corresponding to the Pauli X operator; when the signed qubit corresponds to a Pauli Y operator in the target Pauli string, the measurement basis corresponding to the signed qubit is a measurement basis corresponding to the Pauli Y operator; or when the signed qubit corresponds to a Pauli Z operator in the target Pauli string, the measurement basis corresponding to the signed qubit is a measurement basis corresponding to the Pauli Z operator.

Step 430. Obtain a bit string of the transformed output quantum state on a specified measurement basis by measurement.

In the group of designated measurement bases, except for the measurement basis corresponding to the signed qubit, the measurement bases corresponding to the other unsigned qubits are the same. For example, in FIG. 5, the signed qubit corresponds to the measurement basis X, and the other unsigned qubits all correspond to the measurement basis Z.

Step 440. Output, by the neural network, metadata used for calculating an expected energy value of the target Pauli string according to the bit string.

The bit string obtained by measurement is inputted to the neural network, and the neural network performs forward calculation, to output the metadata used for calculating the expected energy value of the target Pauli string.

Step 450. Calculate the expected energy value of the target Pauli string according to the metadata.

In some embodiments, the expected energy value

$${\left〈\hat{H}\right〉}_{{ψ}_{f}}$$

of the target Pauli string is calculated according to a following formula:

$${\left〈\hat{H}\right〉}_{{ψ}_{f}} = \frac{{\left〈\left(1 - 2 {s}_{0}\right) f \left(0 {s}_{1 : n - 1}\right) f \left(1 {\tilde{s}}_{1 : n - 1}\right)\right〉}_{s}}{{\left〈f {\left(s\right)}^{2}\right〉}_{s}}$$

where ^{f} represents the neural network, ^{S}0 represents a measurement result (a value is 0 or 1) corresponding to the signed qubit, S represents the bit string,

$$0 {s}_{1 : n - 1}$$

represents a bit string obtained by setting a bit corresponding to the signed qubit in the bit string ^{S} to 0, and

$$1 {\tilde{s}}_{1 : n - 1}$$

represents a bit string obtained by setting a bit corresponding to the signed qubit in the bit string ^{S} to 1 and performing corresponding bit inversion on other bits according to the target Pauli string. The so-called bit inversion refers to converting 0 to 1, and converting 1 to 0.

Using FIG. 5 as an example, the bit string S is ^{S}0^{S}1^{S}2^{S}3^{S}4, and the signed qubit is the second qubit. Therefore, the bit string ^{0s}1:n-1 obtained by setting the bit corresponding to the signed qubit in the bit string ^{S} set to 0 is ^{S}₀^{0s}₂^{s}₃^{s}_{4,} and the bit corresponding to the signed qubit in the bit string ^{S} is set to 1. The bit string

$$1 {\tilde{s}}_{1 : n - 1}$$

obtained by performing bit invertion on other bits is

$${s}_{0} 1 {\overline{s}}_{2} {\overline{s}}_{3} {s}_{4.} s ,$$

$$0 {s}_{1 : n - 1}$$

and

$$1 {\tilde{s}}_{1 : n - 1}$$

are respectively inputted to the neural network, and the neural network outputs values of

$$f ( s )$$

,

$$f ( 0 {s}_{1 : n - 1} )$$

and

$$f \left(1 {\tilde{s}}_{1 : n - 1}\right) .$$

Then the formula is entered to calculate the expected energy value

$$\left〈\hat{H}\right〉$$

of the Pauli string X₁, X₂, and Y₃, that is,

$$\left〈\hat{H}\right〉 = \frac{{\left〈( 1 - 2 {s}_{1} ) f ( {s}_{0} 0 {s}_{2} {s}_{3} {s}_{4} ) f ( {s}_{0} 1 {\overline{s}}_{2} {\overline{s}}_{3} {s}_{4} )\right〉}_{S}}{{\left〈f {( {s}_{0} {s}_{1} {s}_{2} {s}_{3} {s}_{4} )}^{2}\right〉}_{S}}$$

.

Step 460. Calculate the expected energy value of the Hamiltonian according to the expected energy values of the k Pauli strings.

For example, the expected energy values of the k Pauli strings are added to obtain the expected energy value of the Hamiltonian. The addition may be direct addition or weighted summation, which is not limited in the present disclosure.

Step 470. Adjust parameters of the parameterized quantum circuit and parameters of the neural network with convergence of the expected energy value of the Hamiltonian as an obj ective.

Step 480. When the expected energy value of the Hamiltonian satisfies a convergence condition, determine the expected energy value of the Hamiltonian satisfying the convergence condition as ground state energy of the target quantum system.

Step 470 to step 480 are the same as step 230 to step 240 in the embodiment in FIG. 2. For details, reference may be made to the foregoing description, which is not repeated in this embodiment.

In an exemplary embodiment, to further simplify a structure of the measurement circuit, the quantum gate corresponding to the unsigned qubit is equivalently replaced by a sign corresponding to a measurement result corresponding to the unsigned qubit when a Pauli operator corresponding to the unsigned qubit in the target Pauli string is the same as a Pauli operator corresponding to the same measurement basis.

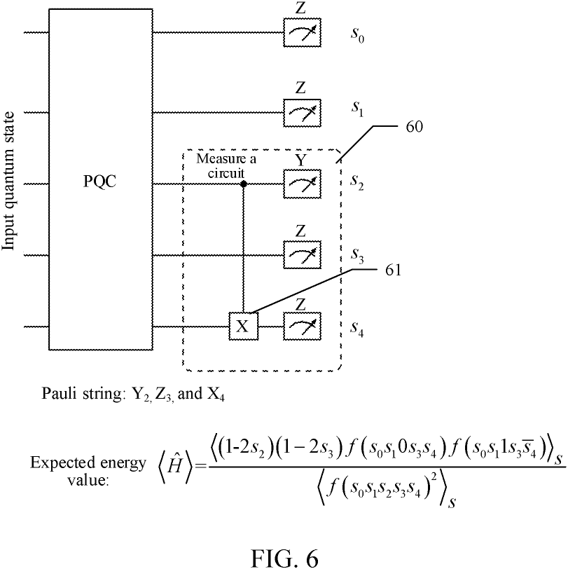

Using FIG. 6 as an example, the target Pauli string is I₀, I₁, Y₂, Z₃, and X_{4,} where the I operator may be ignored. Therefore, the target Pauli string may be recorded as Y₂, Z₃, and X₄. Assuming that the measurement is to be performed on the measurement basis Z, the third qubit (corresponding to the Pauli operator Y₂) may be used as a signed qubit, and other qubits are unsigned qubits. In this case, the measurement circuit 60 corresponding to the target Pauli string may include a two-bit controlled Z gate applied on the third qubit (that is, the signed qubit), the fourth qubit (corresponding to the Pauli Z₃), a two-bit controlled X gate 61 applied on the third qubit (that is, the signed qubit), and the fifth qubit (corresponding to the Pauli X₄). However, to further simplify a structure of the measurement circuit 60, the two-bit controlled Z gate applied on the third qubit (that is, the signed qubit) and the fourth qubit (corresponding to the Pauli operator Z3) may be saved, and a sign 1—2_{s₃} corresponding to the measurement result ^{S}3 corresponding to the fourth qubit is used for equivalent substitution.

If no equivalent substitution is performed, the formula for calculating the expected energy value of the Pauli string Y₂, Z₃, and X₄ is:

$$\left〈\hat{H}\right〉 = \frac{{\left〈( 1 - 2 {s}_{2} ) f ( {s}_{0} {s}_{1} 0 {s}_{3} {s}_{4} ) f ( {s}_{0} {s}_{1} 1 {\overline{s}}_{3} {\overline{s}}_{4} )\right〉}_{S}}{{\left〈f {( {s}_{0} {s}_{1} {s}_{2} {s}_{3} {s}_{4} )}^{2}\right〉}_{S}}$$

. After equivalent substitution, the formula for calculating the expected energy value of the Pauli string is:

$$\left〈\hat{H}\right〉 = \frac{{\left〈\left(1 - 2 {s}_{2}\right) \left(1 - 2 {s}_{3}\right) f \left({s}_{0} {s}_{1} 0 {s}_{3} {s}_{4}\right) f \left({s}_{0} {s}_{1} 1 {s}_{3} {\overline{s}}_{4}\right)\right〉}_{s}}{{\left〈f {\left({s}_{0} {s}_{1} {s}_{2} {s}_{3} {s}_{4}\right)}^{2}\right〉}_{s}}$$

Next, the principle of adding measurement circuits to reduce the resource consumption in the measurement and estimation process is deduced and analyzed.

Due to the non-unitary feature of the post-processing operator, the objective that needs to be optimized is the normalized energy expectation

$${\left〈\hat{H}\right〉}_{f} = \frac{\left〈{ψ}_{f} \left|\hat{H}\right| {ψ}_{f}\right〉}{\left〈{ψ}_{f} \left|{ψ}_{f}\right)\right〉}$$

, where

$$\hat{H}$$

is any Pauli string. The expected energy value of the Hamiltonian may always be decomposed into a simple summation of the expected energy values of a plurality of Pauli strings. Therefore, the measurement and estimation solution may resolve the problem of expected estimation of a single Pauli string.

The denominator

$$\left〈{ψ}_{f} \left|{ψ}_{f}\right)\right〉 = {\sum }_{s ∈ {\left\{0 , 1\right\}}^{n}} {\left|{ψ}_{s}\right|}^{2} {\left|f \left(s\right)\right|}^{2}$$

in the formula, where

$${ψ}_{s} = \left〈s \left|ψ\right)\right〉$$

represents a probability amplitude of a wave function outputted by the parameterized quantum circuit PQC on the measurement basis. An implementation policy corresponding to the formula is very simple: the bit string S is obtained by directly performing measurement on the PQC measurement basis, and then an average

$${\left|f ( s )\right|}^{2}$$

of a plurality of measurement results is calculated. f(S) represents a corresponding output value of the input bit string S of the neural network f .

Using the PQC measurement basis as the measurement basis Z as an example, if the to-be-estimated Pauli string

$$\hat{H}$$

only includes the Pauli Z operator (and may further include

$$\text{the I operator} \left[\begin{matrix}1 & 0 \\ 0 & 1\end{matrix}\right] ) , \text{that is,} \left〈s \left|H\right| {s}^{′}\right〉 = {H}_{s} {δ}_{s {s}^{′}}$$

t(where, ^{S} and ^{s'} represent two bit strings, and

$${δ}_{s s '}$$

is a Kronecker function, which is 1 only when ^{S} and ^{s'} are the same, and is 0 in other cases. Hₛ is the expectation of the Pauli string under the corresponding basis of ^{S} ). Then, for the numerator in the formula, there is:

$$\left〈{ψ}_{f} \left|\hat{H}\right| {ψ}_{f}\right〉 = {{\sum }_{s ∈ {\{ 0 , 1 \}}^{n}} \left|{ψ}_{s}\right|}^{2} {\left|f ( s )\right|}^{2} {H}_{s}$$

. The measurement policy is completely similar to the estimation of the denominator, and the 2 expectation of

$${\left|f ( s )\right|}^{2} {H}_{s}$$

is calculated directly after the bit string ^{S} is measured and obtained by the PQC measurement basis.

The real difficulty of VQE post-processing, which has been considered to require the consumption of exponential resources, is when the Pauli X or Y operator is included in the Pauli string

$$\hat{H}$$

. From the most direct point of view, all qubits need to be measured on the measurement basis Z to obtain the bit string ^{S} due to the need to calculate the enhancement effect of the post-processing, and because the neural network post-processing is built on the measurement basis Z. Then, a value calculated by the neural network f(s)is inputted. However, on the other hand, a Pauli string including the Pauli X or Y operator needs to be measured on the measurement basis X or Y to obtain a corresponding result of the corresponding qubit. That is, there is a conflict: values of X and Z need to be simultaneously obtained on specific qubits in the same measurement. The two may not be simultaneously obtained because the two are not commutative (that is, XZ≠ZX), which is why the exponential resources need to be consumed in the previous implementations.

To implement exponential acceleration of non-unitary post-processing, a specific mathematical structure of the Pauli strings is examined. In the present disclosure, a specific qubit corresponding to the X or Y operator in the Pauli string is defined as a signed qubit, and for the convenience of being reflected in the formula, the signed qubit is recorded as the 0th bit, and the corresponding measurement result is recorded as

$${s}_{0.} \left|\tilde{s}\right〉$$

corresponding to the bit string transformation is defined under the action of the Pauli strings:

$$\hat{H} \left|s\right〉 = S \left(\tilde{s}\right) \left|\tilde{s}\right〉$$

, where S(s) corresponds to a phase factor, and a possible value depends on a specific Pauli operator, which may be one of

$$\pm 1$$

and

$$\pm {i}_{.}$$

Considering

$${\hat{H}}^{2} = 1$$

, there is

$$S ( s ) S \left(\tilde{s}\right) = 1$$

, and a form

$$\hat{H} = {\sum }_{{s}_{0} = 0} S ( s ) \left|s\right〉 \left〈\tilde{s}\right| + S ( \tilde{s} ) \left|\tilde{s}\right〉 \left〈s\right|$$

of the Pauli string is:

$${s}_{1 : n - 1} ∈ {\{ 0 , 1 \}}^{n - 1}$$

The summation keeps the signed qubit fixed at 0, and such a summation is then abbreviated as

$$s ∈ {\left\{0 , 1\right\}}^{n - 1} .$$

All eigenvalues of the Pauli string are ±1, and the corresponding eigenstates of 2ⁿ⁻¹ respectively are:

$$\left|\left(+ , {s}_{1 : n - 1}\right〉\right) = \frac{1}{\sqrt{2}} \left(S ( 0 {s}_{1 : n - 1} ) \left|0 s \left({}_{1 : n - 1}\right〉\right) + \left〈1 \tilde{s} \left({}_{1 : n - 1}\right|\right)\right)$$

; and [0107]

$$\left|- , {s}_{1 : n - 1}\right〉 = \frac{1}{\sqrt{2}} {\left(S \left(0 {s}_{1 : n - 1}\right) \left|0 {s}_{1 : n - 1}\right〉 - \left〈1 {\tilde{s}}_{1 : n - 1}\right|\right)}_{.}$$

Considering that the post-processing neural network output ƒ(s) is a real number (a case of the complex number is explained below), it is obtained that:

$$\begin{matrix}\left〈{ψ}_{f}\right| \hat{H} \left|{ψ}_{f}\right〉 \\ = \left〈ψ\right| \left({\sum }_{s ∈ {\left\{0 , 1\right\}}^{n - 1}} f \left(s\right) f \left(\tilde{s}\right) S \left(s\right) \left|s\right〉 \left〈\tilde{s}\right| + f \left(s\right) f \left(\tilde{s}\right) S \left(\tilde{s}\right) \left|\tilde{s}\right〉 \left〈s\right|\right) \left|ψ\right〉 \\ = \left〈ψ\right| \left({\sum }_{s ∈ {\left\{0 , 1\right\}}^{n - 1}} f \left(s\right) f \left(\tilde{s}\right) \left(\left|+ , s\right〉 \left〈+ , s\right| - \left|- , s\right〉 \left〈- , s\right|\right)\right) \left|ψ\right〉 \\ = {{\sum }_{s ∈ {\left\{0 , 1\right\}}^{n - 1}} {\left|{ψ}_{+ , s}\right|}^{2} f \left(s\right) f \left(\tilde{s}\right) + {\left|{ψ}_{- , s}\right|}^{2} \left(- f \left(s\right) f \left(\tilde{s}\right)\right)}_{;}\end{matrix}$$

and

a final probability amplitude

$${ψ}_{\pm , s} = \left〈\pm , {s}_{1 : n} \vert ψ\right〉$$

is a probability amplitude of the PQC output wave function on a Pauli string eigenstate basis. To implement the measurement on the group of basis, the measurement circuit needs to be introduced (denoted by V) and to be appended to the PQC (denoted by U ). If

$$\left({V}^{†}\right| s 〉 ∞ \left|\pm , {s}_{1 : n - 1}\right) 〉 ,$$

there is exactly

$$\left〈\pm , {s}_{1 : n - 1} \vert ψ\right〉 = \left〈s \vert V U \left(θ\right) \left|0\right)\right〉 .$$

That is, a measurement circuit V needs to be constructed. Correspondingly,

$${V}^{†} \left|s\right〉 ∝ \left(\left|0 {s}_{1 : n - 1}\right〉 + \left(1 - 2 {s}_{0}\right) \hat{H} \left|0 {s}_{1 : n - 1}\right〉\right) ,$$

the construction solution of such a circuit is as follows:

1. For the unsigned qubit other than the signed qubits included in the Pauli string, a two-bit controlled X/Y/Z gate is applied. A specific selection corresponds to an operator type on the corresponding bit, and the control bits are all signed qubits.

In some embodiments, a two-bit quantum gate corresponding to the unsigned qubit is equivalently replaced by a sign corresponding to a measurement result corresponding to the unsigned qubit when a Pauli operator corresponding to the unsigned qubit in the target Pauli string is the same as a Pauli operator corresponding to the same measurement basis, thereby helping to simplify the structure of the measurement circuit.

2. All unsigned qubits except signed qubits are measured on the same measurement basis, and the measurement basis corresponding to the signed qubit is determined according to the Pauli operator corresponding to the signed qubit in the Pauli string.

It may be learnt from the theoretical derivation and experimental solution construction that compared with the VQE, only additional quantum resources of m-1 two-bit quantum gates are required. When the same measurement basis corresponding to the unsigned qubit is the measurement basis Z, m is the quantity of Pauli X and Y operators in the corresponding Pauli string (similar to this in other cases). For common short-range interactions, the number is usually of an order of O(1). Therefore, the only thing that needs to be analyzed if the whole VQNHE framework does not need exponential time is the effect of measurement error. Next, a random error introduced by the expectation of the measurement estimation is analyzed, so as to conclude with certainty that only polynomial resources are required for the current solution.

For the standard VQE framework, the measurement error is estimated as:

$$δ \left(\hat{H}\right) = {\frac{2 \sqrt{p \left(1 - p\right)}}{\sqrt{N}}}_{;}$$

and

where p is the probability that a Pauli string corresponding to +1 is measured. To achieve the accuracy of 1 - ε estimating the Pauli string, the quantity of measurements required is

$$N = 4 p ( 1 - p ) / {ε}^{2}$$

. For a case in which the most difficult expectation is 0 and p = 0.5 , the required quantity of measurements is the order of 1 / ε².

The measurement error estimation for the VQNHE framework includes the ratio of numerator distribution expectation n and denominator distribution expectation ^{d} , and there is: [0119]

$$δ \left(\hat{H}\right) = δ \left(\frac{n}{d}\right) < \left|\frac{δ n}{d \sqrt{N}}\right| + {\left|\frac{δ d n}{{d}^{2} \sqrt{N}}\right|}_{;}$$

and [0120] where

$$δ n$$

is the standard deviation of the numerator distribution expectation n, and

$$δ d$$

is the standard deviation of the denominator distribution expectation d. Considering that an output value of the post-processing of the neural network is limited to the range of

$$1 / d < {r}^{2} , δ d < {r}^{2} / 2$$

, and

$$δ n < 2 {r}^{2 \sqrt{p \left(1 - p\right)}}$$

. Taken together, it is obtained that: [0121]

$$δ \left(\hat{H}\right) < \frac{1}{\sqrt{N}} \left(\frac{δ d + δ n}{d}\right) < \frac{3 {r}^{4}}{2}$$

; and

that is, a theoretical limit of the quantity of measurements required to implement the corresponding accuracy in the case of the VQNHE is 9r⁸ / 4ε² . The value and the VQE ratio have only a polynomial dependence on a range of a function of the neural network and are independent of a system architecture size. Therefore, the VQNHE may be efficiently implemented on the quantum hardware. A theoretical limit is relatively loose, and the quantity of additional measurements required in practical problems is much smaller than the value.

In addition, a description is made by using the theoretical derivation and experimental solution under the VQNHE framework with the output ƒ(s) of the neural network as a real number in the above. For a case in which the output ƒ(s) of the neural network may take a complex number, the VQNHE framework provided in the present disclosure may still be completed efficiently, and the corresponding derivation is as follows.

$$R ( s ) = Re {f}^{*} ( s ) f ( \tilde{s} )$$

and

$$I ( s ) = \text{IM} {f}^{*} ( s ) f ( \tilde{s} )$$

, and the estimation of the numerator is divided into the following two parts: [0125]

$$\begin{matrix}\left〈{ψ}_{f} \left|\hat{H}\right| {ψ}_{f}\right〉 \\ = \left〈ψ \left|\left({\sum }_{s ∈ {\left\{0 , 1\right\}}^{n - 1}} {f}^{*} \left(s\right) f \left(\tilde{s}\right) S \left(s\right) \left|\left(s\right〉 \left〈\tilde{s}\right)\right| + f \left(s\right) {f}^{*} \left(\tilde{s}\right) S \left(\tilde{s}\right) \left|\left(\tilde{s}\right〉 \left〈s\right)\right|\right)\right| ψ\right〉 \\ = \left〈ψ \left|\left({\sum }_{s ∈ {\left\{0 , 1\right\}}^{n - 1}} R \left(s\right) \left(S \left(s\right) \left|\left(s\right〉 \left〈\tilde{s}\right)\right| + S \left(\tilde{s}\right) \left|\left(\tilde{s}\right〉 \left〈s\right)\right|\right) + i I \left(s\right) \left(S \left(s\right) \left|\left(s\right〉 \left〈\tilde{s}\right)\right| - S \left(\tilde{s}\right) \left|\left(\tilde{s}\right〉 \left〈s\right)\right|\right)\right)\right| ψ\right〉\end{matrix}$$

; and

and for a part related to a real part, the measurement and estimation are the same as described above, and the only difference is that a factor is ƒ*ƒ taking the real part.

A part related to an imaginary part may be similarly transferred to another set of bases for measurement:

$$\begin{matrix}\left〈ψ\right| \left({\sum }_{s ∈ {\{ 0 , 1 \}}^{n - 1}} i I ( s ) ( S ( s ) \left|\left(s\right〉 \left〈\tilde{s}\right|\right) - S ( \tilde{s} ) \left|\tilde{s}\right〉 \left〈s\right| )\right) \left|ψ\right〉 \\ = \left〈ψ\right| \left({\sum }_{} i ( s ) \left[\left|+ , s\right〉 ' \left〈+ , s\right| ' - \left|- , s\right〉 ' \left〈- , s\right| '\right]\right) \left|ψ\right〉 \\ = {\sum }_{s ∈ {\left\{0 , 1\right\}}^{n - 1}} \left({\left|{{ψ}^{′}}_{+ , s}\right|}^{2} I \left(s\right) + {\left|{{ψ}^{′}}_{- , s}\right|}^{2} \left(- I \left(s\right)\right)\right)\end{matrix}$$

and

a new basis for expansion of a probability amplitude of an output state of the PQC is:

$$\left|+ , s {}_{1 : n - 2}\right〉 ′ \frac{1}{\sqrt{2}} \left(- i S \left(s\right) \left|0 {s}_{1 : n - 1}\right〉 - \left〈1 {\tilde{s}}_{1 : n - 1}\right|\right) ;$$

and

$$\left|- , s {}_{1 : n - 1}\right〉 ′ \frac{1}{\sqrt{2}} \left(- i S \left(s\right) \left|0 {s}_{1 : n - 1}\right〉 + \left〈1 {\tilde{s}}_{1 : n - 1}\right|\right)$$

Similarly, a measurement circuit V′ needs to be constructed to expect

$${\left(V ′\right)}^{†} \left|s\right〉 ∝ {\left|\pm , {s}_{1 : n - 1}\right〉}^{′} ∝ \frac{1}{\sqrt{2}} \left(- i \left|0 {s}_{1 : n - 1}\right〉 - \left(1 - 2 {s}_{0}\right) \hat{H} \left|0 {s}_{1 : n - 1}\right〉\right) .$$

The construction rule for the measurement circuit V′ is also similar to the case of the real number, and the only difference is that if the Pauli string is the Y(X) operator on the signed qubit, the Pauli string is finally measured on the basis of the signed qubit X(-Y).

In this embodiment of the present disclosure, a measurement circuit is added after the PQC, and an output quantum state of the PQC is used for performing transformation processing corresponding to a Pauli string to obtain the transformed output quantum state. The transformation may reduce the resource consumption in a process of measurement and estimation, so that the measurement and unbiased estimation of Pauli strings and even general Hamiltonian may be completed under the consumption of polynomial resources.

Next, an exemplary description is made on a case of applying the VQNHE framework provided in the present disclosure to a specific model study.

A quantum spin model and a molecular model are respectively considered, and the two types are typical problems in condensed matter physics and quantum chemistry. In addition, the implementation effect of the VQNHE framework on actual quantum hardware is further demonstrated.

Case 1: Calculation of the VQNHE framework on the transverse field Ising model and the Heisenberg model.

Ground state energy values of the one-dimensional transverse field Ising model and the isotropic quantum Heisenberg model are calculated in an optimized manner by using the VQNHE framework. Both models are calculated on twelve grids, and Hamiltonian parameters of corresponding models are all 1 and a periodic boundary condition is taken. The comparison between a result of the VQNHE, a result of the VQE, and a strict result is shown in Table 1 below. Both the VQE and the VQNHE are calculated by using a structure of the same quantum circuit in the same model.

Table 1

| Model | VQE | VQNHE | Strict result |
|---|---|---|---|
| Transverse field Ising model | -14.914 | -15.319 | -15.3226 |
| Heisenberg model | -21.393 | -21.546 | -21.5496 |

Case 2: The VQNHE framework calculates a dissociation curve of lithium hydride (LiH) molecules.

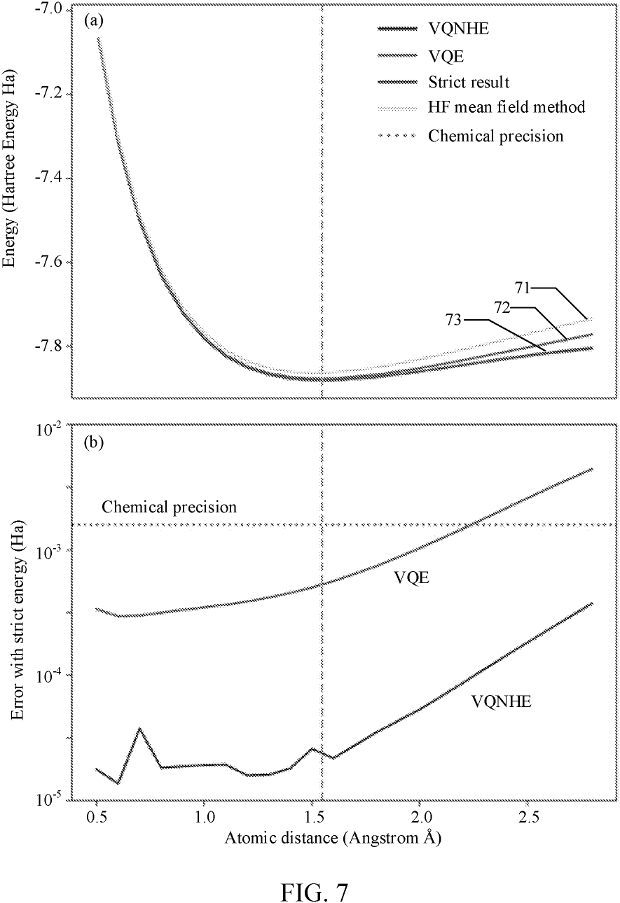

The VQNHE framework may also be applicable to calculating molecular energy. In the example, the VQNHE framework is used for calculating ground state energy of the LiH system corresponding to different atomic distances. In addition, the energy is compared with the energy obtained by the VQE and the energy obtained by a Hartree Fock mean field method. The result is shown in part (a) in FIG. 7. The curve 71 corresponds to the energy obtained by the Hartree Fock mean field method, the curve 72 corresponds to the energy obtained by the VQE, and the curve 73 corresponds to the energy obtained by the VQNHE. The energy obtained by the VQNHE basically coincides with the strict result. It may be learnt from part (b) in FIG. 7, the optimized energy accuracy corresponding to the VQNHE is an order of magnitude higher than the optimized energy accuracy of the VQE. Both the VQNHE and the VQE are calculated on a symmetry-reduced 4-qubit fully active space on the problem. The two algorithms use a structure of the quantum circuit of the same hardware-friendly ansatz, and the structure of the quantum circuit may be shown in FIG. 8.

Case 3: The performance of the VQNHE framework on real hardware and a noisy simulator.

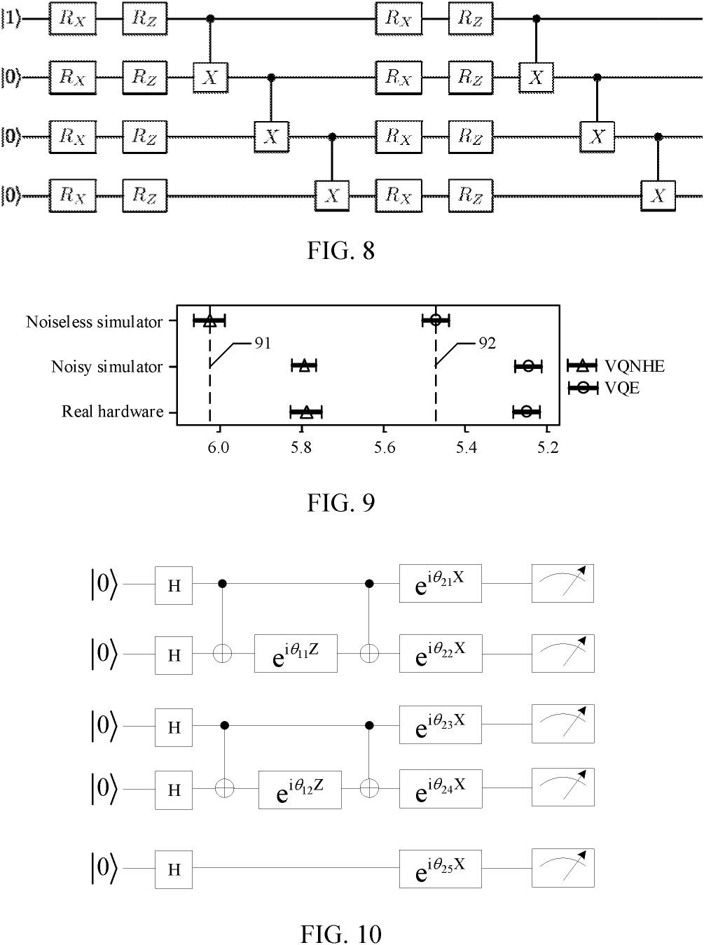

To examine the performance of the VQNHE framework in a non-ideal situation with measurement error and quantum hardware noise, the VQNHE algorithm is run on real IBM quantum hardware and a quantum noise simulation model. Results obtained for the corresponding VQE and VQNHE are shown in FIG. 9. The test model is a transverse field Ising model with a five-grid open boundary condition, and the corresponding circuit structure of the PQC is shown in FIG. 10.

It may be learnt that no matter in an ideal model or in real hardware, a result obtained by the VQNHE framework is far better than a result obtained by the VQE framework that uses the same amount of quantum resources. In addition, under the premise of the same 8192 measurements, the VQNHE method does not introduce the significantly increased measurement error. A line 91 in FIG. 9 is the real ground state energy and the energy obtained when the VQNHE converges under ideal conditions (the two are basically coincident), and a line 92 is the optimal energy of the VQE under ideal conditions. The real data based on the measured bit string is used, a post-processing part of the neural network is re-optimized. The most optimal neural network that deviates from the ideal conditions may instead give the lowest energy estimation. That is, the post-processing part of the neural network may adaptively consider the effect of partial quantum noise, and has specific natural properties of quantum error mitigation (QEM).

The following are apparatus and system embodiments of the present disclosure, and the apparatus and system embodiments correspond to the method embodiments and belong to the same inventive concept. For details not described in detail in the apparatus and system embodiments, reference may be made to the method embodiments of the present disclosure.

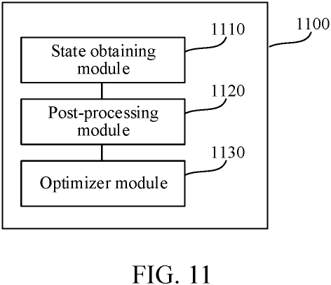

FIG. 11 is a block diagram of an apparatus for estimating ground state energy of a quantum system according to an embodiment of the present disclosure. The apparatus has functions of implementing the foregoing method embodiments. The functions may be implemented by hardware, or may be implemented by hardware executing corresponding software. The apparatus may be a computer device or may be disposed in a computer device. As shown in FIG. 11, the apparatus 1100 may include: a state obtaining module 1110, a post-processing module 1120, and an optimizer module 1130.

The state obtaining module 1110 is configured to obtain output quantum states of n qubits obtained by performing transformation processing on input quantum states of the n qubits through a parameterized quantum circuit, an expected energy value of Hamiltonian of a target quantum system in the output quantum states of the n qubits being a summation result of expected energy values of k Pauli strings obtained by decomposing the Hamiltonian, n being a positive integer, and k being a positive integer.

The post-processing module 1120 is configured to perform post-processing on the output quantum states of the n qubits by using a neural network, and obtain the expected energy value of the Hamiltonian by calculating a post-processing result of the neural network.

The optimizer module 1130 is configured to adjust parameters of the parameterized quantum circuit and parameters of the neural network with convergence of the expected energy value of the Hamiltonian as an objective; and when the expected energy value of the Hamiltonian satisfies a convergence condition, determine the expected energy value of the Hamiltonian satisfying the convergence condition as ground state energy of the target quantum system.

In an exemplary embodiment, the post-processing module 1120 includes: a decomposition unit, a measurement unit, and a calculation unit, where
the decomposition unit is configured to generate a plurality of Pauli strings corresponding to equivalent Hamiltonian of the target quantum system according to a Pauli string obtained by decomposing the Hamiltonian and a Pauli string obtained by decomposing a post-processing operator corresponding to the neural network;
the measurement unit is configured to obtain, for each Pauli string in the plurality of Pauli strings, a bit string of the output quantum states of the n qubits on a measurement basis corresponding to the Pauli string by measurement; and
the calculation unit is configured to calculate and obtain an expected energy value corresponding to each of the plurality of Pauli strings respectively according to a bit string corresponding to each of the plurality of Pauli strings respectively, and calculate the expected energy value of the Hamiltonian according to the expected energy value corresponding to each of the plurality of Pauli strings respectively.

In some embodiments, the decomposition unit is configured to:
perform Taylor expansion on the post-processing operator corresponding to the neural network to obtain t Pauli strings, where t is a positive integer; and
perform a direct product operation on the t Pauli strings and the k Pauli strings obtained by decomposing the Hamiltonian to generate the plurality of Pauli strings corresponding to the equivalent Hamiltonian of the target quantum system.

In an exemplary embodiment, the post-processing module includes: an obtaining unit, a measurement unit, a neural network unit, and a calculation unit, where
the obtaining unit is configured to obtain a target Pauli string in the k Pauli strings, obtain a measurement circuit corresponding to the target Pauli string, and obtain a transformed output quantum state after performing transformation processing corresponding to the target Pauli string on the output quantum states of the n qubits;
the measurement unit is configured to obtain a bit string of the transformed output quantum state on a specified measurement basis by measurement;
the neural network unit is configured to output, by the neural network, metadata used for calculating an expected energy value of the target Pauli string according to the bit string; and
the calculation unit is configured to calculate and obtain the expected energy value of the target Pauli string according to the metadata, and calculate the expected energy value of the Hamiltonian according to the expected energy value of the k Pauli strings.

In some embodiments, the measurement circuit corresponding to the target Pauli string includes a quantum gate corresponding to an unsigned qubit other than signed qubits, so that the unsigned qubit is measured on a same measurement basis, where the signed qubit is a qubit in the n qubits that corresponds to a target Pauli operator in the target Pauli string, and a measurement basis corresponding to the signed qubit is determined according to a Pauli operator corresponding to the signed qubit in the target Pauli string.

In some embodiments, the same measurement basis is a measurement basis corresponding to a first Pauli operator, and the target Pauli operator is a second Pauli operator or a third Pauli operator, where the first Pauli operator, the second Pauli operator, and the third Pauli operator are different from each other, and any Pauli operator of the first Pauli operator, the second Pauli operator, and the third Pauli operator is one of a Pauli X operator, a Pauli Y operator, and a Pauli Z operator.

In some embodiments, the quantum gate corresponding to the unsigned qubit is a two-bit controlled X gate when the unsigned qubit corresponds to the Pauli X operator in the target Pauli string; or
the quantum gate corresponding to the unsigned qubit is a two-bit controlled Y gate when the unsigned qubit corresponds to the Pauli Y operator in the target Pauli string; or
the quantum gate corresponding to the unsigned qubit is a two-bit controlled Z gate when the unsigned qubit corresponds to the Pauli Z operator in the target Pauli string.

In some embodiments, when the signed qubit corresponds to a Pauli X operator in the target Pauli string, the measurement basis corresponding to the signed qubit is a measurement basis corresponding to the Pauli X operator; or
when the signed qubit corresponds to a Pauli Y operator in the target Pauli string, the measurement basis corresponding to the signed qubit is a measurement basis corresponding to the Pauli Y operator; or
when the signed qubit corresponds to a Pauli Z operator in the target Pauli string, the measurement basis corresponding to the signed qubit is a measurement basis corresponding to the Pauli Z operator.

In some embodiments, the calculation unit is configured to calculate the expected energy value

$${\left〈\hat{H}\right〉}_{{ψ}_{f}}$$

of the target Pauli string according to a following formula:

$${\left〈\hat{H}\right〉}_{{ψ}_{f}} = {\frac{{\left〈\left(1 - 2 {s}_{0}\right) f \left(0 {s}_{1 : n - 1}\right) f \left(1 {\tilde{s}}_{1 : n - 1}\right)\right〉}_{s}}{{\left〈f {\left(s\right)}^{2}\right〉}_{s}}}_{;}$$

and

where ƒ represents the neural network, s₀ represents a measurement result corresponding to the signed qubit, s represents the bit string, 0s₁_{:n-1} represents a bit string obtained by setting a bit corresponding to the signed qubit in the bit string to 0, and 1s̃_{1:n-1} represents a bit string obtained by setting a bit corresponding to the signed qubit in the bit string to 1 and performing corresponding bit inversion on other bits according to the target Pauli string.

In some embodiments, the quantum gate corresponding to the unsigned qubit is equivalently replaced by a sign corresponding to a measurement result corresponding to the unsigned qubit when a Pauli operator corresponding to the unsigned qubit in the target Pauli string is the same as a Pauli operator corresponding to the same measurement basis.

In the present disclosure, a neural network is used for performing post-processing on a wave function outputted by the parameterized quantum circuit. The neural network may play the role of a general function approximator, which has stronger expression capability and ground state energy approximation capability than the Jastrow factor, thereby helping to improve the accuracy of estimating the ground state energy.

An exemplary embodiment of the present disclosure further provides a system for estimating ground state energy of a quantum system, including: a parameterized quantum circuit and a computer device. The computer device includes a post-processor and an optimizer.

The parameterized quantum circuit is used for performing transformation processing on input quantum states of n qubits to obtain output quantum states of the n qubits, an expected energy value of Hamiltonian of a target quantum system in the output quantum states of the n qubits being a summation result of expected energy values of k Pauli strings obtained by decomposing the Hamiltonian, n being a positive integer, and k being a positive integer.

The post-processor is configured to perform post-processing on the output quantum states of the n qubits by using a neural network, and obtain the expected energy value of the Hamiltonian by calculating a post-processing result of the neural network; and

the optimizer being configured to adjust parameters of the parameterized quantum circuit and parameters of the neural network with convergence of the expected energy value of the Hamiltonian as an objective; and when the expected energy value of the Hamiltonian satisfies a convergence condition, determine the expected energy value of the Hamiltonian satisfying the convergence condition as ground state energy of the target quantum system.

In an exemplary embodiment, the post-processor includes: a decomposition unit, a measurement unit, and a calculation unit, where
the decomposition unit is configured to generate a plurality of Pauli strings corresponding to equivalent Hamiltonian of the target quantum system according to a Pauli string obtained by decomposing the Hamiltonian and a Pauli string obtained by decomposing a post-processing operator corresponding to the neural network;
the measurement unit is configured to obtain, for each Pauli string in the plurality of Pauli strings, a bit string of the output quantum states of the n qubits on a measurement basis corresponding to the Pauli string measurement; and
the calculation unit is configured to calculate and obtain an expected energy value corresponding to each of the plurality of Pauli strings respectively according to a bit string corresponding to each of the plurality of Pauli strings respectively, and calculate the expected energy value of the Hamiltonian according to the expected energy value corresponding to each of the plurality of Pauli strings respectively.

In some embodiments, the decomposition unit is configured to:
perform Taylor expansion on the post-processing operator corresponding to the neural network to obtain t Pauli strings, where t is a positive integer; and
perform a direct product operation on the t Pauli strings and the k Pauli strings obtained by decomposing the Hamiltonian to generate the plurality of Pauli strings corresponding to the equivalent Hamiltonian of the target quantum system.

In an exemplary embodiment, the system further includes k groups of measurement circuits, and the post-processing module includes an obtaining unit, a measurement unit, a neural network unit, and a calculation unit, and the k groups of measurement circuits are in one-to-one correspondence with the k Pauli strings;
a measurement circuit corresponding to the target Pauli string is used for performing transformation processing corresponding to the target Pauli string on the output quantum states of the n qubits to obtain a transformed output quantum state;
the obtaining unit is configured to obtain the transformed output quantum state;
the measurement unit is configured to obtain a bit string of the transformed output quantum state on a specified measurement basis by measurement;
the neural network unit is configured to output, by the neural network, metadata used for calculating an expected energy value of the target Pauli string according to the bit string; and
the calculation unit is configured to calculate and obtain the expected energy value of the target Pauli string according to the metadata, and calculate the expected energy value of the Hamiltonian according to the expected energy value of the k Pauli strings.

In some embodiments, the measurement circuit corresponding to the target Pauli string includes a quantum gate corresponding to an unsigned qubit other than signed qubits, so that the unsigned qubit is measured on a same measurement basis, where the signed qubit is a qubit in the n qubits that corresponds to a target Pauli operator in the target Pauli string, and a measurement basis corresponding to the signed qubit is determined according to a Pauli operator corresponding to the signed qubit in the target Pauli string.

In some embodiments, the same measurement basis is a measurement basis corresponding to a first Pauli operator, and the target Pauli operator is a second Pauli operator or a third Pauli operator, where the first Pauli operator, the second Pauli operator, and the third Pauli operator are different from each other, and any Pauli operator of the first Pauli operator, the second Pauli operator, and the third Pauli operator is one of a Pauli X operator, a Pauli Y operator, and a Pauli Z operator.

In some embodiments, the quantum gate corresponding to the unsigned qubit is a two-bit controlled X gate when the unsigned qubit corresponds to the Pauli X operator in the target Pauli string; or
the quantum gate corresponding to the unsigned qubit is a two-bit controlled Y gate when the unsigned qubit corresponds to the Pauli Y operator in the target Pauli string; or
the quantum gate corresponding to the unsigned qubit is a two-bit controlled Z gate when the unsigned qubit corresponds to the Pauli Z operator in the target Pauli string.

In some embodiments, when the signed qubit corresponds to a Pauli X operator in the target Pauli string, the measurement basis corresponding to the signed qubit is a measurement basis corresponding to the Pauli X operator; or
when the signed qubit corresponds to a Pauli Y operator in the target Pauli string, the measurement basis corresponding to the signed qubit is a measurement basis corresponding to the Pauli Y operator; or
when the signed qubit corresponds to a Pauli Z operator in the target Pauli string, the measurement basis corresponding to the signed qubit is a measurement basis corresponding to the Pauli Z operator.

In some embodiments, the calculation unit is configured to calculate the expected energy value

$${\left〈\hat{H}\right〉}_{{ψ}_{f}}$$

the target Pauli string according to a following formula:

$${\left〈\hat{H}\right〉}_{{ψ}_{f}} = {\frac{{\left〈\left(1 - 2 {s}_{0}\right) f \left(0 {s}_{1 : n - 1}\right) f \left(1 {\tilde{s}}_{1 : n - 1}\right)\right〉}_{s}}{{\left〈f {\left(s\right)}^{2}\right〉}_{s}}}_{;}$$

and

where ƒ represents the neural network, ^{s}₀ represents a measurement result corresponding to the signed qubit, ^{s} represents the bit string,

$$0 {s}_{t : n - 1}$$

represents a bit string obtained by setting a bit corresponding to the signed qubit in the bit string to 0, and

$$1 {\tilde{s}}_{1 : n - 1}$$

represents a bit string obtained by setting a bit corresponding to the signed qubit in the bit string to 1 and performing corresponding bit inversion on other bits according to the target Pauli string.

In some embodiments, the quantum gate corresponding to the unsigned qubit is equivalently replaced by a sign corresponding to a measurement result corresponding to the unsigned qubit when a Pauli operator corresponding to the unsigned qubit in the target Pauli string is the same as a Pauli operator corresponding to the same measurement basis.

When the apparatus and system provided in the foregoing embodiments implements functions of the apparatus, it is illustrated with an example of division of each functional module or unit. In the practical application, the function distribution may be finished by different functional modules according to the requirements, that is, the internal structure of the device is divided into different functional modules/units, to implement all or some of the functions described above. In addition, the apparatus and system provided in the foregoing embodiments and method embodiments belong to one conception. For the specific implementation process, refer to the method embodiments, and details are not described herein again.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

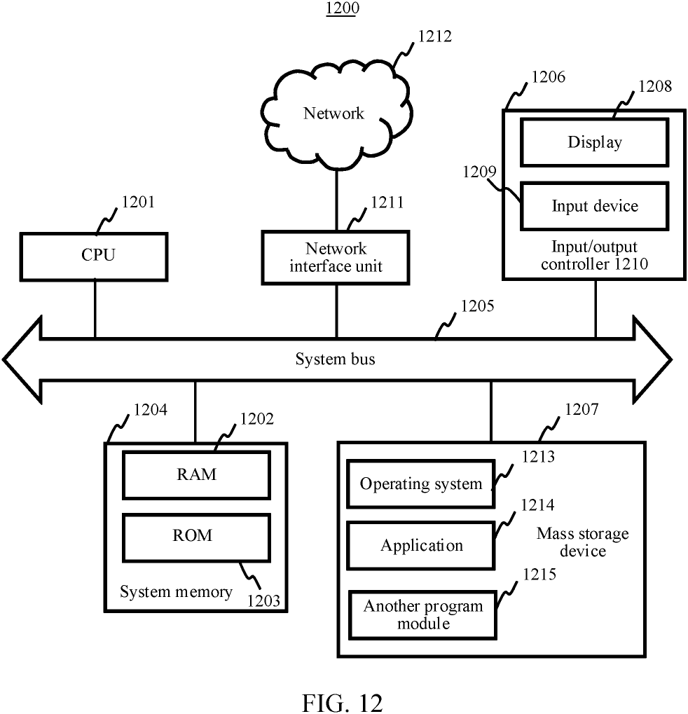

FIG. 12 is a schematic structural diagram of a computer device according to an embodiment of the present disclosure. The computer device may be any electronic device with data storage and computing capabilities, and the computer device may be configured to implement the method for estimating the ground state energy of the quantum system provided in the foregoing embodiments. Specifically:

the computer device 1200 includes a central processing unit (CPU), a graphics processing unit (GPU), and a field programmable gate array (FPGA) 1201, including a system memory 1204 of a random access memory (RAM) 1202 and a read only memory (ROM) 1203, and a system bus 1205 connecting the system memory 1204 and the CPU 1201. The computer device 1200 further includes a basic input/output system (I/O system) 1206 configured to transmit information between components in the server, and a mass storage device 1207 configured to store an operating system 1213, an application program 1214, and another program module 1215.

In some embodiments, The basic I/O system 1206 includes a display 1208 configured to display information and an input device 1209 such as a mouse or a keyboard that is used for inputting information by a user. The display 1208 and the input device 1209 are both connected to the CPU 1201 by using an input/output controller 1210 connected to the system bus 1205. The basic I/O system 1206 may further include the input/output controller 1210 to receive and process inputs from a plurality of other devices such as a keyboard, a mouse, and an electronic stylus. Similarly, the input/output controller 1210 further provides an output to a display screen, a printer, or another type of output device.

The mass storage device 1207 is connected to the CPU 1201 by using a mass storage controller (not shown) connected to the system bus 1205. The mass storage device 1207 and a computer-readable medium associated with the large-capacity storage device provide non-volatile storage to the computer device 1200. That is, the mass storage device 1207 may include a computer-readable medium (not shown) such as a hard disk or a compact disc read-only memory (CD-ROM) drive.

In general, the computer-readable medium may include a computer storage medium and a communication medium. The computer storage medium includes volatile and non-volatile media, and removable and non-removable media implemented by using any method or technology and configured to store information such as a computer-readable instruction, a data structure, a program module, or other data. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may know that the computer storage medium is not limited to the foregoing types. The system memory 1204 and the mass storage device 1207 may be collectively referred to as a memory.

According to the embodiments of the present disclosure, the computer device 1200 may further be connected, through a network such as the Internet, to a remote computer on the network and run. That is, the computer device 1200 may be connected to a network 1212 by using a network interface unit 1211 connected to the system bus 1205, or may be connected to another type of network or a remote computer system (not shown) by using a network interface unit 1211.

The memory further includes a computer program, the computer program being stored in the memory, and being configured to be executed by one or more processors to implement the method for estimating the ground state energy of the quantum system.

In an exemplary embodiment, a computer-readable storage medium is further provided, the computer-readable storage medium storing a computer program, the computer program, when executed by a processor of a computer device, implementing the method for estimating the ground state energy of the quantum system.

In some embodiments, the computer-readable storage medium may include: a read-only memory (ROM), a random-access memory (RAM), a solid state drive (SSD), an optical disc, or the like. The RAM may include a resistance random access memory (ReRAM) and a dynamic random access memory (DRAM).

In an exemplary embodiment, a computer program product or a computer program is further provided, the computer program product or the computer program including computer instructions, the computer instructions being stored in a computer-readable storage medium. A processor of a computer device reads the computer instructions from the computer-readable storage medium, and the processor executes the computer instructions, to cause the computer device to perform the method for estimating the ground state energy of the quantum system.

It is to be understood that “plurality of” mentioned in the specification means two or more. “And/or” describes an association relationship for describing associated objects and represents that three relationships may exist. For example, A and/or B may represent the following three cases: only A exists, both A and B exist, and only B exists. The character “/” in this specification generally indicates an “or” relationship between the associated objects. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of the present disclosure.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for estimating ground state energy of a quantum system, performed by a computer device, the method comprising:
performing transformation processing on input quantum states of n qubits through a parameterized quantum circuit, to output quantum states of the n qubits, an expected energy value of Hamiltonian of a target quantum system in the output quantum states of the n qubits being a summation result of expected energy values of k Pauli strings obtained by decomposing the Hamiltonian, n and k being positive integers;
performing post-processing on the output quantum states of the n qubits by using a neural network, and obtaining the expected energy value of the Hamiltonian by calculating a post-processing result of the neural network;
adjusting parameters of the parameterized quantum circuit and parameters of the neural network by using a convergence condition of the expected energy value of the Hamiltonian as an objective; and
when the expected energy value of the Hamiltonian satisfies the convergence condition, determining the expected energy value of the Hamiltonian satisfying the convergence condition as ground state energy of the target quantum system.

2. The method according to claim 1, wherein the performing post-processing on the output quantum states of the n qubits by using a neural network, and obtaining the expected energy value of the Hamiltonian by calculating a post-processing result of the neural network comprises:
generating a plurality of Pauli strings corresponding to equivalent Hamiltonian of the target quantum system according to a Pauli string obtained by decomposing the Hamiltonian and a Pauli string obtained by decomposing a post-processing operator corresponding to the neural network;
for one Pauli string in the plurality of Pauli strings, obtaining a bit string of the output quantum states of the n qubits on a measurement basis corresponding to the Pauli string by measurement;
calculating expected energy values corresponding to the plurality of Pauli strings respectively according to bit strings that respectively correspond to the plurality of Pauli strings; and
calculating the expected energy value of the Hamiltonian according to the expected energy values corresponding to the plurality of Pauli strings.

3. The method according to claim 2, wherein the generating a plurality of Pauli strings corresponding to equivalent Hamiltonian of the target quantum system according to a Pauli string obtained by decomposing the Hamiltonian and a Pauli string obtained by decomposing a post-processing operator corresponding to the neural network comprises:
performing Taylor expansion on the post-processing operator corresponding to the neural network to obtain t Pauli strings, wherein t is a positive integer; and
performing a direct product operation on the t Pauli strings and the k Pauli strings obtained by decomposing the Hamiltonian to generate the plurality of Pauli strings corresponding to the equivalent Hamiltonian of the target quantum system.

4. The method according to claim 1, wherein the performing post-processing on the output quantum states of the n qubits by using a neural network, and obtaining the expected energy value of the Hamiltonian by calculating a post-processing result of the neural network comprises:
for a target Pauli string in the k Pauli strings, obtaining a measurement circuit corresponding to the target Pauli string, and obtaining a transformed output quantum state after performing transformation processing corresponding to the target Pauli string on the output quantum states of the n qubits;
obtaining a bit string of the transformed output quantum state on a specified measurement basis by measurement;
outputting, by the neural network, metadata used for calculating an expected energy value of the target Pauli string according to the bit string;
calculating and obtaining the expected energy value of the target Pauli string according to the metadata; and
calculating the expected energy value of the Hamiltonian according to the expected energy values of the k of Pauli strings.

5. The method according to claim 4, wherein the measurement circuit corresponding to the target Pauli string comprises a quantum gate corresponding to an unsigned qubit other than signed qubits, and the unsigned qubit is measured on a same measurement basis, wherein the signed qubit is a qubit in the n qubits that corresponds to a target Pauli operator in the target Pauli string, and a measurement basis corresponding to the signed qubit is determined according to a Pauli operator corresponding to the signed qubit in the target Pauli string.

6. The method according to claim 5, wherein the same measurement basis is a measurement basis corresponding to a first Pauli operator, and the target Pauli operator is a second Pauli operator or a third Pauli operator, wherein the first Pauli operator, the second Pauli operator, and the third Pauli operator are different from each other, and the first Pauli operator, the second Pauli operator, and the third Pauli operator is one of a Pauli X operator, a Pauli Y operator, and a Pauli Z operator.

7. The method according to claim 5, wherein
the quantum gate corresponding to the unsigned qubit is a two-bit controlled X gate when the unsigned qubit corresponds to the Pauli X operator in the target Pauli string; or
the quantum gate corresponding to the unsigned qubit is a two-bit controlled Y gate when the unsigned qubit corresponds to the Pauli Y operator in the target Pauli string; or
the quantum gate corresponding to the unsigned qubit is a two-bit controlled Z gate when the unsigned qubit corresponds to the Pauli Z operator in the target Pauli string.

8. The method according to claim 5, wherein
when the signed qubit corresponds to a Pauli X operator in the target Pauli string, the measurement basis corresponding to the signed qubit is a measurement basis corresponding to the Pauli X operator; or
when the signed qubit corresponds to a Pauli Y operator in the target Pauli string, the measurement basis corresponding to the signed qubit is a measurement basis corresponding to the Pauli Y operator; or
when the signed qubit corresponds to a Pauli Z operator in the target Pauli string, the measurement basis corresponding to the signed qubit is a measurement basis corresponding to the Pauli Z operator.

9. The method according to claim 5, wherein the quantum gate corresponding to the unsigned qubit is equivalently replaced by a sign corresponding to a measurement result corresponding to the unsigned qubit when a Pauli operator corresponding to the unsigned qubit in the target Pauli string is the same as a Pauli operator corresponding to the same measurement basis.

10. An apparatus for estimating ground state energy of a quantum system, comprising:
a processor and a memory, the memory storing a computer program, the computer program being loaded and executed by the processor to implement:
performing transformation processing on input quantum states of n qubits through a parameterized quantum circuit, to output quantum states of the n qubits, an expected energy value of Hamiltonian of a target quantum system in the output quantum states of the n qubits being a summation result of expected energy values of k Pauli strings obtained by decomposing the Hamiltonian, n and k being positive integers;
performing post-processing on the output quantum states of the n qubits by using a neural network, and obtaining the expected energy value of the Hamiltonian by calculating a post-processing result of the neural network;
adjusting parameters of the parameterized quantum circuit and parameters of the neural network by using a convergence condition of the expected energy value of the Hamiltonian as an objective; and
when the expected energy value of the Hamiltonian satisfies the convergence condition, determining the expected energy value of the Hamiltonian satisfying the convergence condition as ground state energy of the target quantum system.

11. The apparatus according to claim 10, wherein the performing post-processing on the output quantum states of the n qubits by using a neural network, and obtaining the expected energy value of the Hamiltonian by calculating a post-processing result of the neural network comprises:
generating a plurality of Pauli strings corresponding to equivalent Hamiltonian of the target quantum system according to a Pauli string obtained by decomposing the Hamiltonian and a Pauli string obtained by decomposing a post-processing operator corresponding to the neural network;
for one Pauli string in the plurality of Pauli strings, obtaining a bit string of the output quantum states of the n qubits on a measurement basis corresponding to the Pauli string by measurement;
calculating expected energy values corresponding to the plurality of Pauli strings respectively according to bit strings that respectively correspond to the plurality of Pauli strings; and
calculating the expected energy value of the Hamiltonian according to the expected energy values corresponding to the plurality of Pauli strings.

12. The apparatus according to claim 11, wherein the generating a plurality of Pauli strings corresponding to equivalent Hamiltonian of the target quantum system according to a Pauli string obtained by decomposing the Hamiltonian and a Pauli string obtained by decomposing a post-processing operator corresponding to the neural network comprises:
performing Taylor expansion on the post-processing operator corresponding to the neural network to obtain t Pauli strings, wherein t is a positive integer; and
performing a direct product operation on the t Pauli strings and the k Pauli strings obtained by decomposing the Hamiltonian to generate the plurality of Pauli strings corresponding to the equivalent Hamiltonian of the target quantum system.

13. The apparatus according to claim 10, wherein the performing post-processing on the output quantum states of the n qubits by using a neural network, and obtaining the expected energy value of the Hamiltonian by calculating a post-processing result of the neural network comprises:
for a target Pauli string in the k Pauli strings, obtaining a measurement circuit corresponding to the target Pauli string, and obtaining a transformed output quantum state after performing transformation processing corresponding to the target Pauli string on the output quantum states of the n qubits;
obtaining a bit string of the transformed output quantum state on a specified measurement basis by measurement;
outputting, by the neural network, metadata used for calculating an expected energy value of the target Pauli string according to the bit string;
calculating and obtaining the expected energy value of the target Pauli string according to the metadata; and
calculating the expected energy value of the Hamiltonian according to the expected energy values of the k of Pauli strings.

14. The apparatus according to claim 13, wherein the measurement circuit corresponding to the target Pauli string comprises a quantum gate corresponding to an unsigned qubit other than signed qubits, and the unsigned qubit is measured on a same measurement basis, wherein the signed qubit is a qubit in the n qubits that corresponds to a target Pauli operator in the target Pauli string, and a measurement basis corresponding to the signed qubit is determined according to a Pauli operator corresponding to the signed qubit in the target Pauli string.

15. The apparatus according to claim 14, wherein the same measurement basis is a measurement basis corresponding to a first Pauli operator, and the target Pauli operator is a second Pauli operator or a third Pauli operator, wherein the first Pauli operator, the second Pauli operator, and the third Pauli operator are different from each other, and the first Pauli operator, the second Pauli operator, and the third Pauli operator is one of a Pauli X operator, a Pauli Y operator, and a Pauli Z operator.

16. The apparatus according to claim 14, wherein
the quantum gate corresponding to the unsigned qubit is a two-bit controlled X gate when the unsigned qubit corresponds to the Pauli X operator in the target Pauli string; or
the quantum gate corresponding to the unsigned qubit is a two-bit controlled Y gate when the unsigned qubit corresponds to the Pauli Y operator in the target Pauli string; or
the quantum gate corresponding to the unsigned qubit is a two-bit controlled Z gate when the unsigned qubit corresponds to the Pauli Z operator in the target Pauli string.

17. The apparatus according to claim 14, wherein
when the signed qubit corresponds to a Pauli X operator in the target Pauli string, the measurement basis corresponding to the signed qubit is a measurement basis corresponding to the Pauli X operator; or
when the signed qubit corresponds to a Pauli Y operator in the target Pauli string, the measurement basis corresponding to the signed qubit is a measurement basis corresponding to the Pauli Y operator; or
when the signed qubit corresponds to a Pauli Z operator in the target Pauli string, the measurement basis corresponding to the signed qubit is a measurement basis corresponding to the Pauli Z operator.

18. The apparatus according to claim 14, wherein the quantum gate corresponding to the unsigned qubit is equivalently replaced by a sign corresponding to a measurement result corresponding to the unsigned qubit when a Pauli operator corresponding to the unsigned qubit in the target Pauli string is the same as a Pauli operator corresponding to the same measurement basis.

19. A non-transitory computer-readable storage medium, storing a computer program, the computer program, when loaded and executed by a processor, causing the processor to implement:
performing transformation processing on input quantum states of n qubits through a parameterized quantum circuit, to output quantum states of the n qubits, an expected energy value of Hamiltonian of a target quantum system in the output quantum states of the n qubits being a summation result of expected energy values of k Pauli strings obtained by decomposing the Hamiltonian, n and k being positive integers;
performing post-processing on the output quantum states of the n qubits by using a neural network, and obtaining the expected energy value of the Hamiltonian by calculating a post-processing result of the neural network;
adjusting parameters of the parameterized quantum circuit and parameters of the neural network by using a convergence condition of the expected energy value of the Hamiltonian as an objective; and
when the expected energy value of the Hamiltonian satisfies the convergence condition, determining the expected energy value of the Hamiltonian satisfying the convergence condition as ground state energy of the target quantum system.

20. The storage medium according to claim 19, wherein the performing post-processing on the output quantum states of the n qubits by using a neural network, and obtaining the expected energy value of the Hamiltonian by calculating a post-processing result of the neural network comprises:
generating a plurality of Pauli strings corresponding to equivalent Hamiltonian of the target quantum system according to a Pauli string obtained by decomposing the Hamiltonian and a Pauli string obtained by decomposing a post-processing operator corresponding to the neural network;
for one Pauli string in the plurality of Pauli strings, obtaining a bit string of the output quantum states of the n qubits on a measurement basis corresponding to the Pauli string by measurement;
calculating expected energy values corresponding to the plurality of Pauli strings respectively according to bit strings that respectively correspond to the plurality of Pauli strings; and
calculating the expected energy value of the Hamiltonian according to the expected energy values corresponding to the plurality of Pauli strings.
